(19) United States
(12) Patent Application Publication
(10) Pub. No.: US 2022/0046484 A1
(43) Pub. Date: Feb. 10, 2022

(54) Method and Functions for Handling a UE's Access to a DN

(71) Applicant: Telefonaktiebolaget LM Ericsson (publ), Stockholm (SE)

(72) Inventors: Helen Örtenblad, Göteborg (SE); Jan Backman, Kärna (SE); Göran Hall, Mölndal (SE)

(21) Appl. No.: 17/276,183

(22) PCT Filed: Sep. 26, 2018
(86) PCT No.: PCT/EP2018/076195

§ 371 Date: Mar. 15, 2021

(51) Int. Cl. H04W 36/00; H04L 12/715; H04L 29/08; H04W 40/34

(52) U.S. Cl. CPC H04W 36/0007; H04L 45/64; H04W 40/34; H04L 67/2842; H04L 67/327; H04L 67/147

(57) ABSTRACT

The embodiments herein relate to a method performed by a SMF (110) for handling a UEs (101) access to a DN (130) in a 5G communications system. The SMF (110) obtains at least one anycast address supported at a DN/I (130/I) which is accessible by the UE (101) from its location. The SMF (110) sends instructions to a UPF/c (105/c) to report usage of the at least one anycast address. The SMF (110) receives, from the UPF/c (105/c), information that usage of the anycast address has been detected. When usage of the anycast address has been detected, the SMF (110) determines that future usage of the anycast address should be routed to the DN/I (130/I) via the UPF/I (105/I).

### TECHNICAL FIELD

Embodiments herein relate generally to a Session Management Function (SMF), a method performed by the SMF, a central User Plane Function (UPF/c), a method performed by the UPF/c, a User Equipment (UE) and a method performed by the UE. More particularly the embodiments herein relate to enabling routing of a data packet from the UE to a Data Network (DN) in a Fifth Generation (5G) communications system.

### BACKGROUND

The 5G system allows that a Protocol Data Unit (PDU) session, i.e. connection to gain Internet Protocol (IP) connectivity, can be served simultaneously by a central access typically to the internet or a PDN that provides the entry portal to the service, as well as access to a local PDN that e.g. serves the purpose of providing the part of the service that is sensitive to latency and/or is dependent on information that is relevant only in the particular area where the local PDN is accessible.

In order to enable access to the local PDN, the SMF must have information as to what User Plane Functions (UPF(s)) can provide access to a local Data Network (DN/l) and make the lookup based on the actual UE location. Each such access point to a DN/l is identified in the 5G system with a DN Access Identifier (DNAI).

The UPF interfacing the local network in reference point N6 diverts the uplink traffic from the UE to the local network based on either (a) the destination address, e.g. normal routing, or (b) the UE source address, e.g. for the case of Internet Protocol version 6 Multi-Homing (IPv6MH) or IPv4 where the UE uses different addresses for traffic to the two DNs. The latter avoids that the routing table might grow so that the user plane throughput may be degraded.

The existence of the local network is not transparent at the UE in that the destination address for a service is different depending on what DN provides the service. It is desirable that the use of a DN/l is transparent to the UE, i.e. the UE can use a common destination address regardless of which DN that provides the service.

Therefore, there is a need to at least mitigate or solve these issues.

### SUMMARY

An objective of embodiments herein is therefore to obviate at least one of the above disadvantages and to provide improved UE access to a DN.

According to a first aspect, the object is achieved by a method performed by a SMF for handling a UEs access to a DN in a 5G communications system. The SMF obtains at least one anycast address supported at a DN/l which is accessible by the UE from its location. The SMF sends instructions to a UPF/c to report usage of the at least one anycast address. The SMF receives, from the UPF/c, information that usage of the anycast address has been detected. When usage of the anycast address has been detected, the SMF determines that future usage of the anycast address should be routed to the DN/l via a local User Plane Function (UPF/l).

According to a second aspect, the object is achieved by a method performed by a UPF/c for handling a UE's access to a DN in a 5G communications system. The UPF/c receives instructions from a SMF to report usage of at least one anycast address. The at least one anycast address is supported at a DN/l which is accessible by the UE from its location. The UPF/c detects usage of the at least one anycast address. The anycast address has been used to access a central data Network (DN/c) via the UPF/c. The UPF/c sends, to the SMF, information that usage of the anycast address has been detected.

According to a third aspect, the object is achieved by a method performed by a UE for handling the UE's access to a DN in a 5G communications system. The UE sends a data packet with an anycast address to a DN/c, and resends the data packet with the anycast address.

According to a fourth aspect, the object is achieved by a SMF in a 5G communications system. The SMF is operative to obtain at least one anycast address supported at a DN/l which is accessible by a UE from its location. The SMF is operative to send instructions to a UPF/c to report usage of the at least one anycast address, and to receive, from the UPF/c, information that usage of the anycast address has been detected. The SMF is operative to, when usage of the anycast address has been detected, determine that future usage of the anycast address should be routed to the DN/l via a UPF/l.

According to a fifth aspect, the object is achieved by a UPF/c in a 5G communications system. The UPF/c is operative to receive instructions from a SMF to report usage of at least one anycast address. The at least one anycast address is supported at a DN/l which is accessible by a UE from its location. The UPF/c is operative to detect usage of the at least one anycast address. The anycast address has been used to access a DN/c via the UPF/c. The UPF/c is operative to send, to the SMF, information that usage of the anycast address has been detected.

According to a sixth aspect, the object is achieved by a UE in a 5G communications system. The UE is operative to send a data packet with an anycast address to a DN/c, and to resend the data packet with the anycast address.

Since future usage of the anycast address should be routed to the DN/l via the UPF/l, the UE accesses a geographically closer DN/l compared to the DN/c, which improves the UE's access in that resource utilization is improved, latency is reduced etc.

Embodiments herein afford many advantages, of which a non-exhaustive list of examples follows:

An advantage of the embodiments herein is that the service being handled in the DN/l is handled without requiring any specific support in the UE.

Another advantage of the embodiments herein is that they enable dynamic adaptation to the network configuration and UE location.

A further advantage of the embodiments herein is that the UPF/l is inserted in the traffic path only in case of actual usage of the locally provided services.

Further advantages of the embodiments herein is that they enable improved network resource utilization, simplified operator-3PP cooperation, improved end user Quality of Service (QoS), reduced transport utilization and reduced transport costs, reduced latency etc.

The embodiments herein are not limited to the features and advantages mentioned above. A person skilled in the art will recognize additional features and advantages upon reading the following detailed description.

### BRIEF DESCRIPTION OF THE DRAWINGS

The embodiments herein will now be further described in more detail by way of example only in the following detailed description by reference to the appended drawings illustrating the embodiments and in which:

FIG. 1 is a schematic block diagram illustrating an example of a network architecture for a 5G system.

FIG. 2 is a schematic block diagram illustrating anycast addresses.

FIG. 3a is a signaling diagram illustrating an example of a method.

FIG. 3b is a schematic block diagram illustrating paths for data packets.

FIG. 4a, 4b are signaling diagrams illustrating an example of automated access to DN/l with forward to the DN/c—with Uplink Classifier (ULCL) breakout.

FIG. 5a, 5b, 5c are signaling diagrams illustrating an example of automated access to DN/l with forward to the DN/c—with IPv6MH breakout.

FIG. 6a, 6b are signaling diagrams illustrating an example of automated access to DN/l dropping packets to the DN/c—with ULCL breakout.

FIG. 7a, 7b, 7c are signaling diagrams illustrating an example of automated access to DN/l dropping packets to the DN/c—with IPv6MH breakout.

FIG. 8 is a flow chart illustrating an example method performed by the SMF.

FIG. 9 is a flow chart illustrating an example method performed by the UPF/c.

FIG. 10 is a flow chart illustrating an example method performed by the UE.

FIG. 11 is a schematic block diagram illustrating an example of a SMF, a UPF/c and a UE.

The drawings are not necessarily to scale and the dimensions of certain features may have been exaggerated for the sake of clarity. Emphasis is instead placed upon illustrating the principle of the embodiments herein.

### DETAILED DESCRIPTION

The embodiments herein relate to automatic detection of using an anycast address at a DN/c which is also available at a DN/l closer to the UE, and redirecting the traffic to the Application Server (AS) with that anycast address at that DN/l. Subsequent interactions use the actual address. It applies to a scenario with IPv6MH breakout of traffic and to ULCL breakout of traffic. Breakout of traffic may also be referred to as offload of traffic. Before continuing to describe this in more detail, an example of a network architecture in which the embodiment herein may be implemented will be described.

ULCL is a functionality supported by an UPF for diverting traffic to local data networks based on traffic matching filters applied to the UE traffic. Multi-Homing may be described as when there are two or more network connections to the same type of network. A purpose of multi-homing is to increase reliability and/or performance.

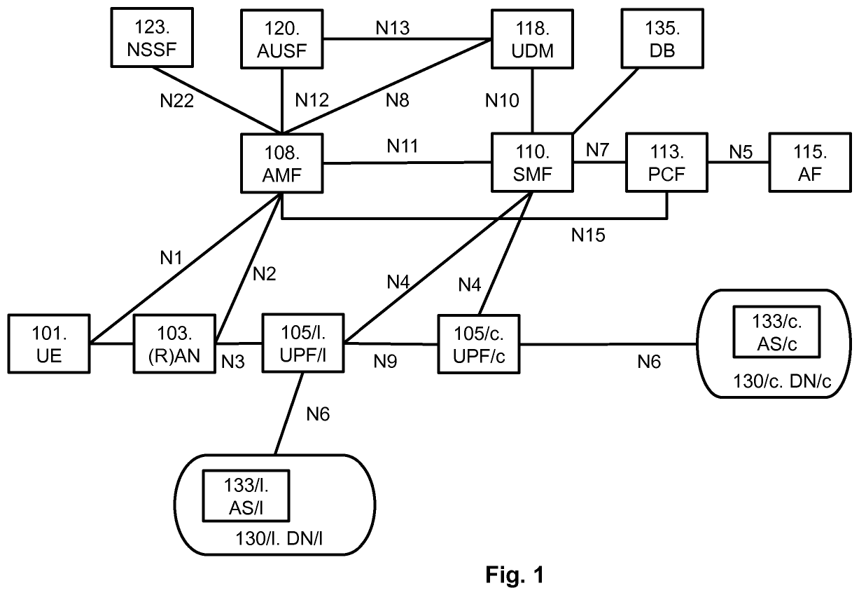

FIG. 1 depicts an example of a 5G network architecture in which embodiments herein may be implemented. In FIG. 1, a UE 101 is adapted to be connected to and served by a (Radio) Access Network (R)AN 103.

The UE 101 may be a device by which a subscriber may access services offered by an operator's network and services outside operator's network to which the operator's radio access network and core network provide access, e.g. access to the Internet. The device may be any device, mobile or stationary, enabled to communicate in the communications network, for instance but not limited to e.g. wireless device, mobile phone, smart phone, sensors, meters, vehicles, household appliances, medical appliances, media players, cameras, Machine to Machine (M2M) device, Device to Device (D2D) device, Internet of Things (IoT) device, terminal device, communication device or any type of consumer electronic, for instance but not limited to television, radio, lighting arrangements, tablet computer, laptop or Personal Computer (PC). The UE 101 may be portable, pocket storable, hand held, computer comprised, or vehicle mounted devices, enabled to communicate voice and/or data, via the radio access network, with another entity, such as another UE or a server.

The (R)AN 103 may comprise a (R)AN node (not illustrated in FIG. 1) such as an access node or radio access node. The (R)AN node may be a base station such as an NodeB, evolvedNodeB (eNB), next generation Node B (gNB), Base Transceiver Station (BTS), a Radio Network Controller (RNC), a Base Station Controller (BSC) Distributed Unit (DU), Central Unit Control Plane (CU-CP) and Central Unit User Plane (CU-UP) etc. The reference number 103 may be used when referring to any of the (R)AN and the (R)AN node herein.

The (R)AN 103 is adapted to be connected to a UPF 105 via a N3 interface. The UPF 105 is adapted to be connected to another UPF 105 via a N9 interface. The UPF 105 may be a local or a central UPF. In the example shown in FIG. 1, the left most UPF 105 is a UPF/l 105/l and the right most UPF 105 is a UPF/c 105/c. When the reference number 105 is used without /l or /c, it refers to any of the central or local UPFs 105. The UPF 105 may comprise at least one of the following functionalities:
Anchor point for Intra-/Inter-Radio Access Technology (RAT) mobility, when applicable.
External PDU Session point of interconnect to DN 130.
Packet routing & forwarding.
Packet inspection.
User Plane part of policy rule enforcement.
Lawful intercept, e.g. User Plane (UP) collection.
Traffic usage reporting.
QoS handling for user plane.
Uplink Traffic verification.
Transport level packet marking in the uplink and downlink.
Downlink packet buffering and downlink data notification triggering.
Sending and forwarding of one or more “end marker” to the source Next Generation (NG)-RAN node.
Address Resolution Protocol (ARP) proxying.

The UE 101 is adapted to be connected to an Access and Mobility Management Function (AMF) 108 via a N1 interface, and the (R)AN 103 is adapted to be connected to the AMF 108 via a N2 interface. The AMF 108 may comprise at least one of the following functionalities:
Termination of RAN Control Plane (CP) interface N2.
Termination of Non-Access-Stratum (NAS), N1, NAS ciphering and integrity protection.
Registration management.
Connection management.
Reachability management.
Mobility Management.
Lawful intercept.
Provide transport for Session Management (SM) messages between UE 101 and SMF 110.
Transparent proxy for routing SM messages.
Access Authentication.
Access Authorization.
Provide transport for Short Message Service (SMS) messages between UE 101 and SMF 110.
Security Anchor Functionality (SEAF).
Location Services management for regulatory services.
Provide transport for Location Services messages between UE 101 and Location Management Function (LMF) as well as between RAN 103 and LMF.
Evolved Packet System (EPS) Bearer Identity (ID) allocation for interworking with EPS.
UE mobility event notification.

Each of the UPFs 105 is adapted to be connected to a SMF 110 via a respective N4 interface. The SMF 110 may comprise at least one of the following functionalities:
Session Management e.g. Session Establishment, modify and release, including tunnel maintain between UPF 105 and (R)AN node 103.
UE IP address allocation & management.
Dynamic Host Configuration Protocol version 4 (DHCPv4) and DHCP version 6 (DHCPv6) functions.
ARP proxying.
Selection and control of UP function.
Configures traffic steering at UPF 105 to route traffic to proper destination.
Termination of interfaces towards Policy control functions.
Lawful intercept.
Charging data collection and support of charging interfaces.
Control and coordination of charging data collection at UPF.
Termination of SM parts of NAS messages.
Downlink Data Notification (DDN).
Initiator of Access Network (AN) specific SM information.
Determine Session and Service Continuity (SSC) mode of a session.
Roaming functionality.

The AMF 108 and the SMF 110 are adapted to be connected to each other via a N11 interface.

The SMF 110 is adapted to be connected to a Policy Control Function (PCF) 113 via a N7 interface. The PCF 113 is adapted to be connected to the AMF 108 via a N15 interface. The PCF 113 may comprise at least one of the following functionalities:
Supports unified policy framework to govern network behaviour.
Provides policy rules to Control Plane function(s) to enforce them.
Accesses subscription information relevant for policy decisions in a Unified Data Repository (UDR).

The PCF 113 is adapted to be connected to an Access Function (AF) 115 via a N5 interface. The AF 115 may comprise at least one of the following functionalities:
Application influence on traffic routing.
Accessing Network Exposure Function.
Interacting with the Policy framework for policy control.

The SMF 110 is adapted to be connected to a Unified Data Management (UDM) 118 via a N10 interface. The UDM 118 may comprise at least one of the following functionalities:
Generation of Third Generation Partnership Project (3GPP) Authentication and Key Agreement (AKA) Authentication Credentials.
User Identification Handling.
Support of de-concealment of privacy-protected subscription identifier (SUCI).
Access authorization based on subscription data.
UE's Serving Network Function (NF) Registration Management.
Support to service/session continuity.
Mobile Terminal (MT)-SMS delivery support.
Lawful Intercept Functionality.
Subscription management.
SMS management.

The UDM 118 is adapted to be connected to the AMF 108 via a N8 interface.

The UDM 118 is adapted to be connected to an Authentication Server Function (AUSF) 120 via a N13 interface. The AUSF 120 supports authentication for 3GPP access and untrusted non-3GPP access.

The AUSF 120 is adapted to be connected to the AMF 108 via a N12 interface.

The AMF 108 is adapted to be connected to a Network Slice Selection Function (NSSF) 123 via a N22 interface. The NSSF 123 supports at least one of the following functionalities:
Selecting the set of Network Slice instances serving the UE,
Determining the Allowed Network Slice Selection Assistance Information (NSSAI) and, if needed, the mapping to the Subscribed-NSSAIs (S-NSSAIs),
Determining the Configured NSSAI and, if needed, the mapping to the Subscribed S-NSSAIs,
Determining the AMF Set to be used to serve the UE, or, based on configuration, a list of candidate AMF(s).

Each of the UPFs 105 is adapted to be connected to a respective DN 130 via a N6 interface. The DN 130 may be e.g. operator services, Internet access or 3rd party services. A DN 130 may be a local or a central DN 130. A DN/l is, according to 3GPP Technical Specification (TS) 23.501 V15.2.0 (2018-06) “a DN that is accessible by the UE only in specific locations, that provides connectivity to a specific Data Network Name (DNN), and whose availability is provided to the UE”. The DN/c may be described as a (data) network where there peering point from the mobile network e.g. at the regional or national level. A central DN may be for example Internet. In the example shown in FIG. 1, the left most DN 130 is a DN/l 130/l and the right most DN 130 is a DN/c 130/c. The DN/l 130/l is adapted to be connected to the UPF/l 105/l and the DN/c 130/c is adapted to be connected to the UPF/c 105/c. When the reference number 130 is used without /l or /c, it refers to any of the central or local DNs 130.

Each DN 130 comprises at least one Application Server (AS) 133. The DN/l 130/l comprises at least one local AS (AS/l) 133/l and the DN/c 130/c comprises at least one central AS (AS/c) 133c. When the reference number 133 is used without /l or /c, it refers to any of the central or local AS 133. An AS 133 may be referred to as an application herein for the sake of simplicity. The AS 133 may be described as providing a service, and the AS 133 may therefore also be referred to as a service herein.

A database (DB) 135 is adapted to be connected to the SMF 110. The DB 135 may be a standalone database or it may be co-located with the SMF 110. The DB 135 may comprise at least one anycast address.

The terms reference point and interface are sometimes used interchangeably herein.

FIG. 1 illustrates network functions, and the network function is defined in 3GPP TS 23.501 V15.2.0 (2018-06) as a “processing function in a network, which has defined functional behaviour and 3GPP defined interfaces.”

It should be noted that the communication links in the network architecture exemplified in FIG. 1 may be of any suitable kind including either a wired or wireless link. The link may use any suitable protocol depending on type and level of layer (e.g. as indicated by the OSI model) as understood by the person skilled in the art.

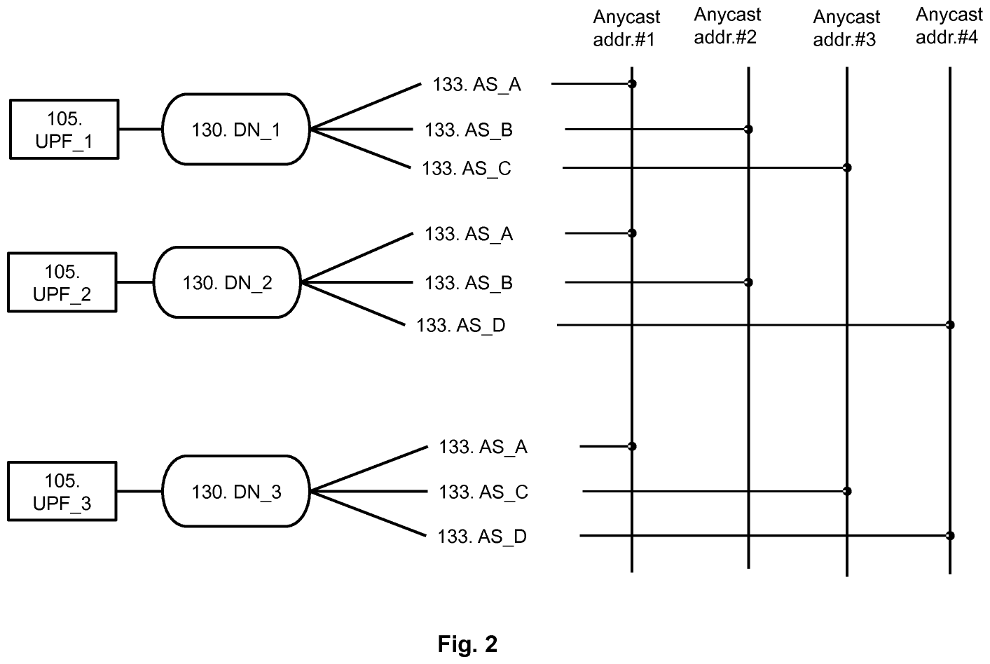

The term anycast address mentioned earlier will now be described. An anycast address is defined as “An identifier for a set of interfaces (typical belonging to different nodes). A packet sent to an anycast address is delivered to one of the interfaces identified by that address (the “nearest” one, according to the routing protocols' measure of distance)” by the Request for Comments (RFC) 4291. It may also be described as a one-to-one-of-many association where a single destination address has multiple routing paths to multiple endpoint destinations. With an anycast address, data packets are often routed to the geographically nearest member of an anycast group, i.e. to the member with the “least costly route” according to the routing protocols. But this may coincide with the geographically closest member. Thus, a data packet sent to an anycast address is delivered to the geographically closest interface identified by the anycast address. A graphical illustration of the anycast address is shown in FIG. 2. FIG. 2 shows an example with three UPFs 105, UPF_1, UPF_2 and UPF_3. Note that the number of UPFs is not limited to three as shown in FIG. 2, but it may be any suitable number. Each UPF 105 is adapted to be connected to a respective DN 130. Each DN 130 comprises at least one AS 133 or is connected to at least one AS 133. As mentioned above, the AS 133 may be referred to as an application or a service. In the example in FIG. 2, UPF_1 105 is adapted to be connected to DN_1 130 which comprises the following three AS' 133: AS_A, AS_B and AS_C. UPF_2 105 is adapted to be connected to DN_2 130 which comprises the following three AS' 133: AS_A, AS_B and AS_D. UPF_3 105 is adapted to be connected to a DN_3 130 which comprises the following three AS' 133: AS_A, AS_C and AS_D. As seen in FIG. 2, AS_A is available via DN_1, DN_2 and DN_3. AS_B is available via DN_1 and DN_2, AS_C is available via DN_1 and DN_3. AS_D is available via DN_2 and DN_3. As also illustrated in FIG. 2, an AS 133 has an anycast address, and this address is the same regardless of where the instance of the AS 133 is located. Thus, AS_A has anycast address #1, AS_B has anycast address #2, AS_C has anycast address #3 and AS_D has anycast address #4.

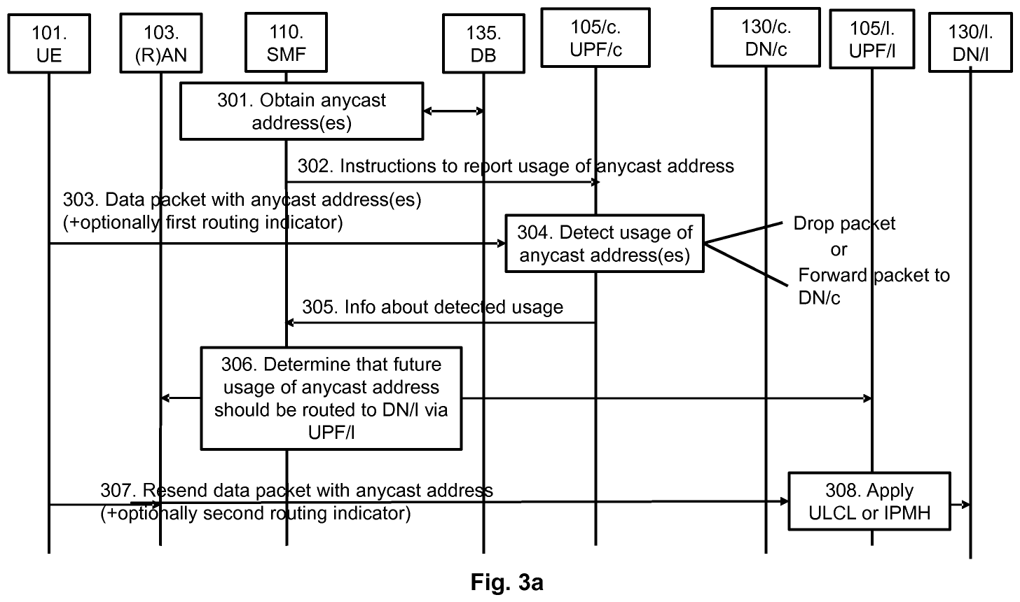

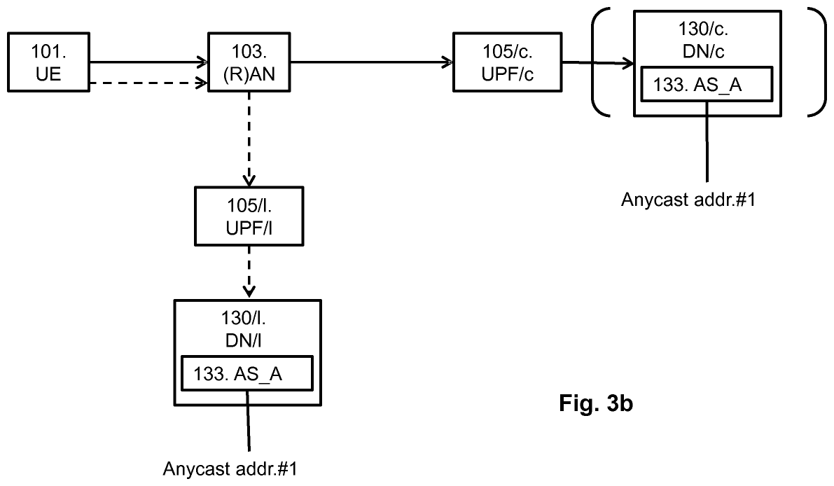

FIG. 3a is a signaling diagram illustrating an example of a method. Before step 301 is performed, signaling has taken place between the UE 101 and the SMF 110 in order to establish a PDU session between the UE 101 and the DN/c 130c. The method seen in FIG. 3a comprises at least one of the following steps, which steps may be performed in any suitable order than described below:

Step 301

The SMF 110 obtains at least one anycast address supported at a DN/l 130/l which is accessible by the UE 101 from its location, i.e. the DN/l 130/l which is located geographically closest to the UE 101. With the anycast address, the SMF 110 comprises information about the DN/l 130/l which is located geographical closest to the UE 101 and the UPF/l 105/l associated with the DN/l 130/l. The anycast address may e.g. anycast address #1, or it may be anycast address #1, anycast address #2 and anycast address #3. Note that the numbers of obtained anycast address listed above are just examples, and that any number of anycast addresses from one and upwards is applicable. In the following description of FIG. 3a, anycast address #1 is used as an example.

This anycast address(es) may be obtained from the DB 135 for example in case the SMF 110 does already have such anycast address. Another example for when the any cast address may be obtained from the DB 135 may be when the SMF 110 already have the anycast address, but this anycast address has expired, i.e. it was too long ago since the ancyast address was obtained. The anycast address maybe obtained internally within the SMF 110, for example when the SMF 110 already have the anycast address and when this has not expired, i.e. the anycast address was recently obtained and can now be reused. The anycast address may be an IP address.

A trigger for performing step 301 may be that the signaling between the UE 101 and the SMF 110 is completed, e.g. signaling for setting up a PDN connection.

Step 302

The SMF 110 sends instructions to the UPF/c 105/c that it should report usage of the anycast address #1 back to the SMF 110. The reporting may be upon detection of the usage, it may be on regular basis, it maybe when an existing message is already to be sent to the SMF 110 with other types of information etc.

Step 303

The UE 101 sends a data packet with the anycast address #1 to the UPF/c. The anycast address #1 may be seen as a destination address for the data packet. The path of the data packet is illustrated with solid arrows in FIG. 3b. The brackets around the DN/c 130/c indicates that the data packet may or may not reach the DN/c 130/c, which will be described in more detail in step 304 below. The anycast address #1 goes in this example to AS_1 133. The data packet may be sent using a first routing indicator. The data packet sent form the UE 101 to the UPF/c may be referred to as UpLink (UL) traffic. The first routing indicator indicates where the data packet should be routed. The first routing indicator may be a first IPv6 prefix in case of IPv6 and a first subnet mask in case of IPv4. An IPv6 prefix is a part of an IP address, and the IPv6 prefix is used for routing data packets such as e.g. IPv6 packets. The first IPv6 prefix may be of any suitable length and format. In addition to the IPv6 prefix, the IPv6 address comprises other parts. The first routing indicator may also be referred to as a first routing prefix. In case IPv4 is used instead of IPv6, the first routing indicator may be a first subnet mask. Even though most examples herein are described with reference to Ipv6, they are equally applicable to IPv4.

Step 304

The UPF/c 105/c detects the usage of the anycast address #1. When the UPF/c 105/c has detected the usage of the anycast address #1, it may either drop the data packet from step 103b or it may forward it to the UPF/c. If the data packet is dropped, it is not transmitted further by the UPF/c 105/c. In other words, the UPF/c 105/c performs traffic inspection and detects the usage of the any cast address #1.

Step 305

The UPF/c reports the usage of the anycast address #1 to the SMF 110.

Step 306

Triggered by the reported usage of the anycast address #1, the SMF 110 determines that future usage of anycast address #1 should be routed to DN/l 130/l via the UPF/l 105/l. The SMF 110 may inform the (R)AN 103 and/or the UPF/l 105/l about the decision. Using other words, future data traffic with anycast address #1 should be broken out to the DN/l 130/l.

Step 307

The UE 101 resends the data packet from step 303 with anycast address #1, i.e. with the same anycast address as in step 303. Reasons for the resending may be that the UE 101 has not received any confirmation of receipt of the data packet from step 303 or that a timer has expired. The data packet may be resent with a second routing indicator, i.e. a different routing indicator compared to in step 303.

The second routing indicator indicates where the data packet should be routed. The second routing indicator may be a second IPv6 prefix in case of IPv6 and a second subnet mask in case of IPv4. The second IPv6 prefix may be of any suitable length and format. The second routing indicator may also be referred to as a second routing prefix. In case IPv4 is used instead of IPv6, the second routing indicator may be a second subnet mask.

The resent packet is routed via the UPF/l 105/l to the DN/l 130/l which is located geographically closer to the UE 101 than the DN/c 130/c. The data packet resent form the UE 101 to the UPF/c may be referred to as UL traffic.

Step 308

The UPF/l 105/l receives the resent data packet with anycast address #1 and applies either ULCL or IPv6MH for further routing of the data packet to the DN/l 130/l. The choice of ULCL or IPV6MH may be configured in the UPF/l 105/l meaning that it knows if the ULCL feature and/or the IPv6MH feature are supported in the specific UPF 105.

The UPF/l 105/l, i.e. the UPF 105 interfacing the local network in reference point N6, diverts the uplink traffic from the UE 101 to the DN/l 130/l based on either (a) the destination address for ULCL, also referred to as “normal” routing, or (b) the UE source address for the case of IPv6MH where the UE 101 uses different addresses for traffic to the two DNs 130. The latter avoids that the routing table might grow so that the user plane throughput may be degraded.

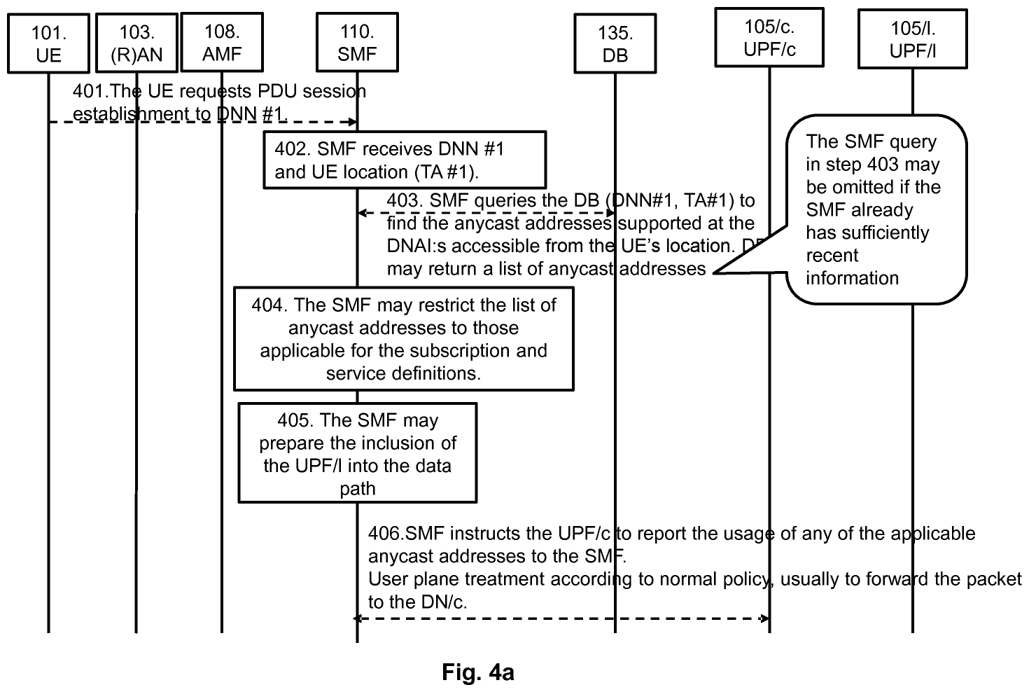

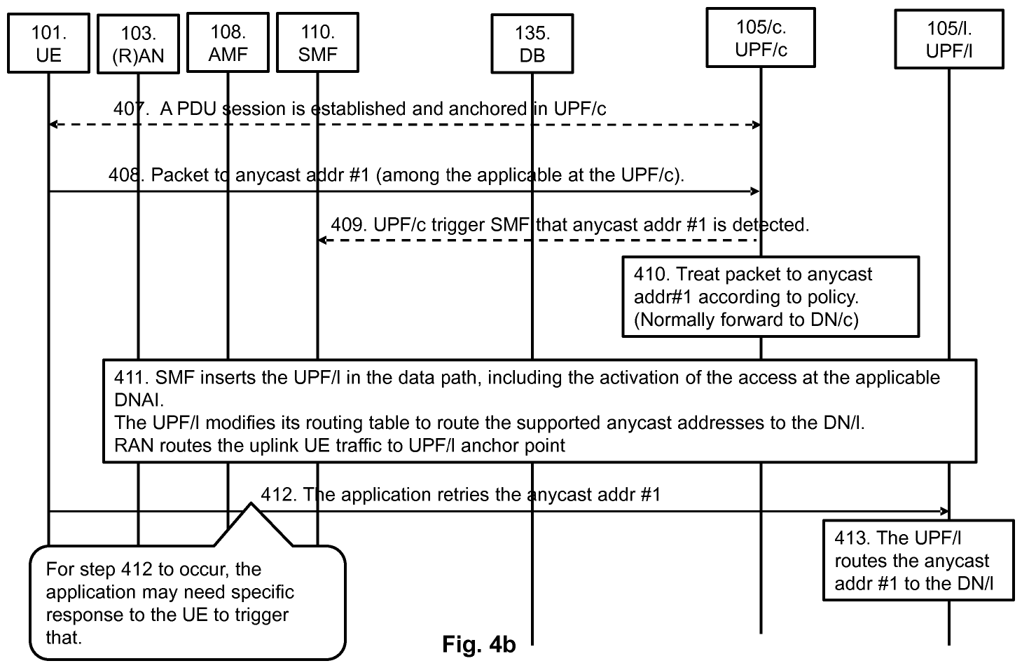

As mentioned earlier, the embodiments herein relate to an automated access to a DN/l 130/l. It may be several alternatives for this, for example either using ULCL breakout or IPv6HM breakout. In addition, each of these alternatives may be done in different ways, e.g. with forwarding to a DN/c 130/c or with dropping of packet to a DN/c 130/c. Some example methods illustrating automated access to a DN/l 130/l will now be described with reference to FIGS. 4, 5, 6 and 7. Below is an overview of the alternatives illustrated in the figs.:

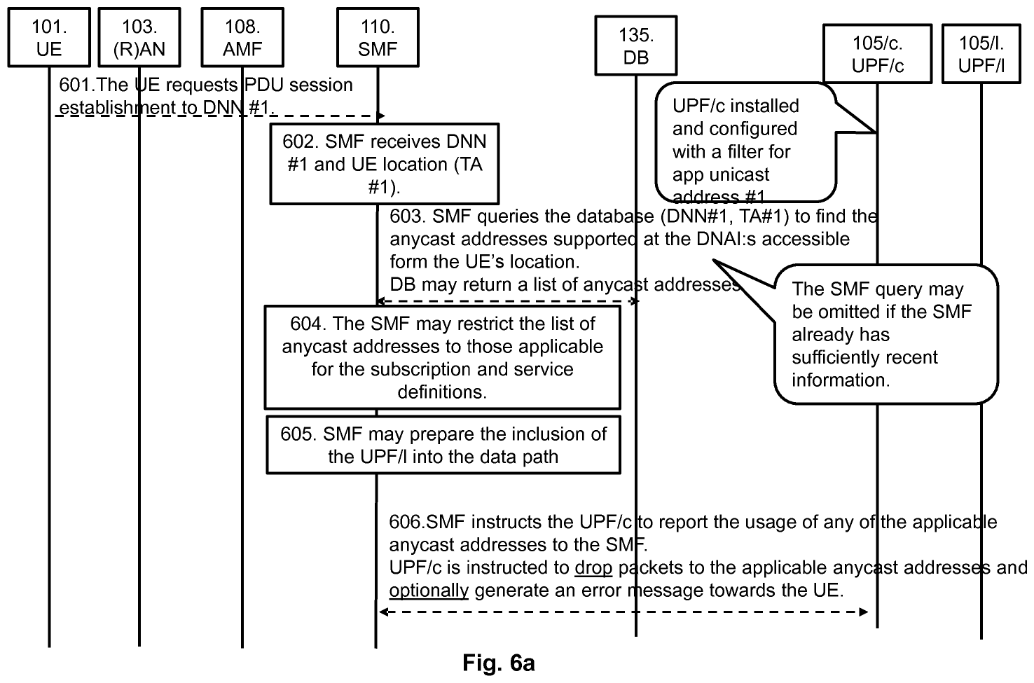

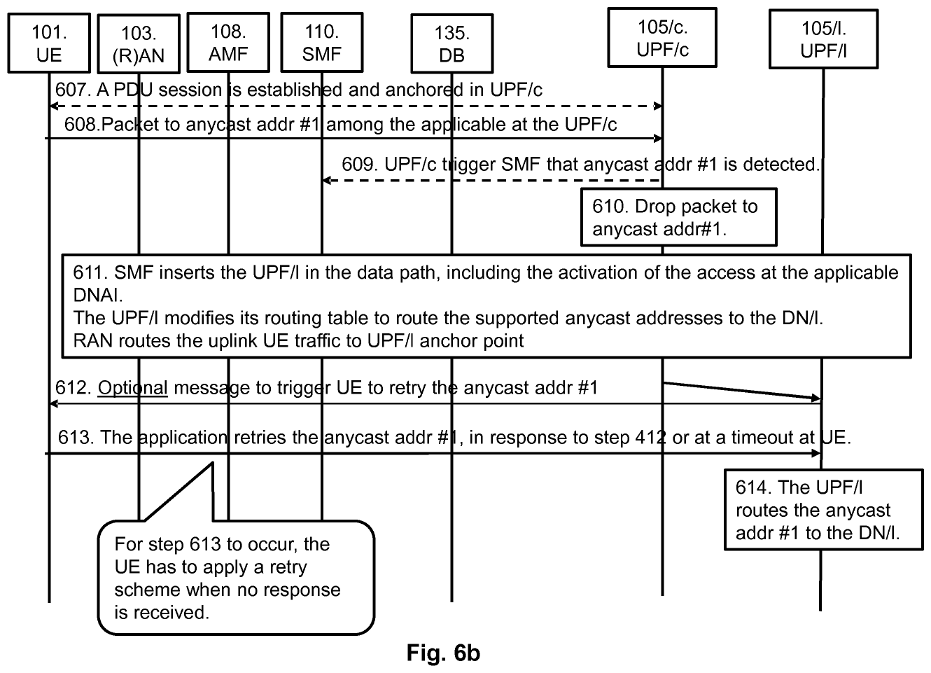

1. Automated access to DN/l 130/l—with ULCL breakout: FIGS. 4a, 4b and FIGS. 6a, 6b
1.1. Forward to DN/c 130/c: FIGS. 4a, 4b
1.2. Drop packets to DN/c 130/c: FIGS. 6a, 6b

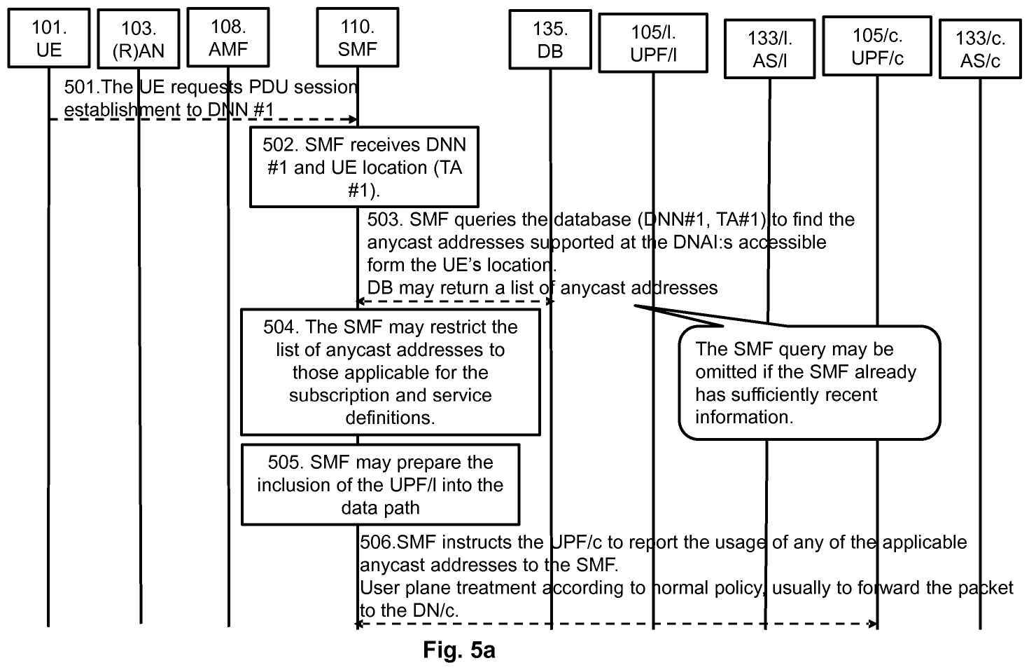

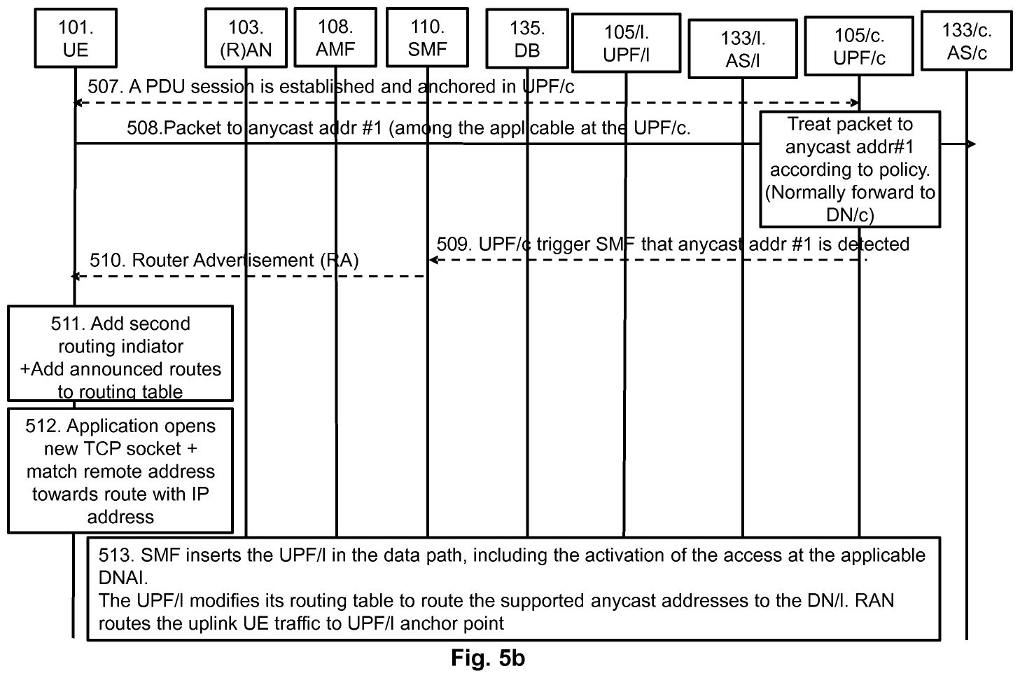

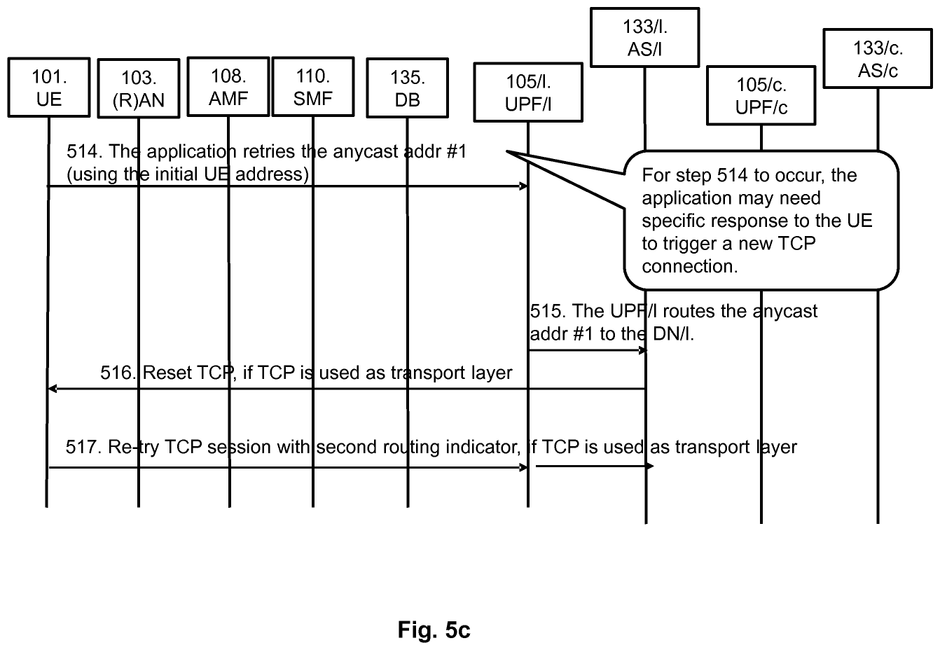

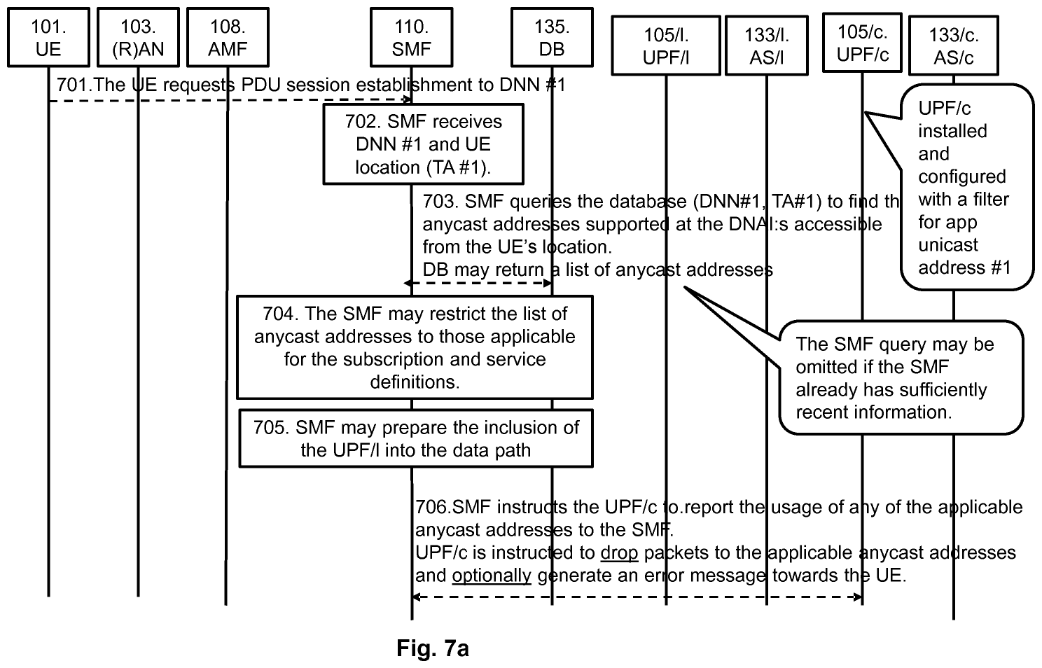

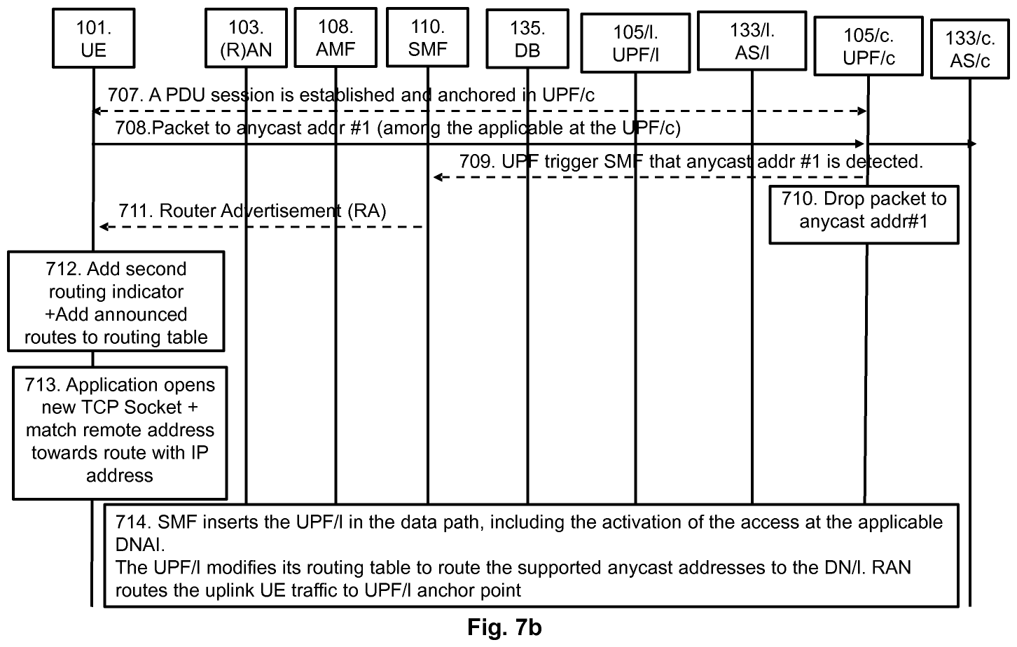

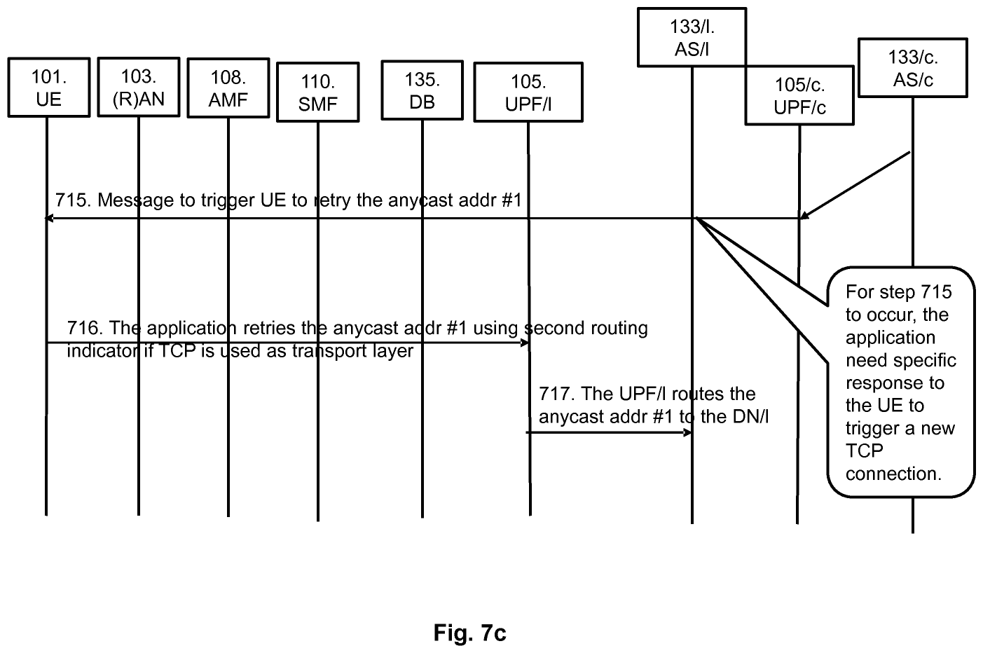

2. Automated access to DN/l 130/l—with IPv6HM breakout: FIGS. 5a, 5b, 5c and FIGS. 7a, 7b and 7c
2.1. Forward to DN/c 130/c: FIGS. 5a, 5b, 5c
2.2. Drop packets to DN/c 130/c: FIGS. 7a, 7b, 7c

FIG. 4a and FIG. 4b are signalling diagrams illustrating an example of an automated access to a DN/l 130/l with forward to a DN/c 130/c with ULCL breakout, i.e. alternative 1.1 above. FIG. 4a illustrates steps 401-406 and FIG. 4b illustrates steps 407-413. FIG. 4b is a continuation of step 4a such that steps 407-413 are performed after steps 401-406. The dotted arrows in FIGS. 4a and 4b represent control plane traffic and the solid arrows represent user plane traffic. The method illustrates in FIGS. 4a and 4b comprises at least one of the following steps, which steps may be performed in any suitable order than described below:

Step 401

This step is seen in FIG. 4a. 401. The UE 101 sends a request for PDU session establishment to DNN #1. The request is sent to the SMF 110. DNN #1 is an example of a DNN to which the UE 101 requests session establishment, and any other DNN is equally applicable. The DNN #1 may also be referred to as a first DNN. DNN is a name used to gain access to a DN 130. The UE 101 is at a location when sending the request, and this location may be referred to as Tracking Area (TA) #1 or a first TA.

Step 402

This step is seen in FIG. 4a. The SMF 110 receives the request from the UE 101. With the request, the SMF 110 receives DNN #1 and the UE location. The UE location may be for example TA #1.

Step 403

This step is seen in FIG. 4a. This step corresponds to step 301 in FIG. 3a. This is an optional step. The SMF 110 may query the DB 135 to find if there are anycast address(es) supported at the DNAI's accessible from the UE's location. Together with the query, the SMF 110 sends the DNN #1 and TA #1 from step 402 to the DB 135. The DB 135 receives the query and may return at least one anycast address. The DB 135 returns at least one anycast address if there are any applications distributed to the DN/l 130/l. Thus, there may be one, two or more anycast addresses that is returned to the SMF 110. If there are two or more anycast addresses, then they may be organized in the form of a list of anycast addresses.

The SMF query may be omitted if the SMF 110 already has sufficiently recent information regarding the anycast addresses.

Step 404

This step is seen in FIG. 4a. This is an optional step. The SMF 110 may restrict the list of anycast addresses to those applicable for the subscription and service definitions.

Restriction of the list of anycast addresses may be done for reasons like subscriber differentiation, i.e. the subscriber has access to what he/she pays for. It may also be that different subscribers are only allowed to use certain services for security reasons, parental control, etc. The subscription and service definitions are the overall subscription and service definition of the subscriber—it e.g. can accept or not accept PDU session establishment in step 401 depending on the subscriber is allowed to access that Access Point Name (APN) or not.

Step 405

This step is seen in FIG. 4a. This is an optional step. The SMF 110 may prepare the inclusion of the UPF/l 105/l into the data path. With step 405, step 411 may be performed faster.

Step 406

This step is seen in FIG. 4a. This corresponds to step 302 in FIG. 3a. The SMF 110 instructs the UPF/c 105/c to report the usage of any of the applicable anycast addresses to the SMF 110.

User plane treatment is performed according to normal policy, usually to forward the packet to the DN/c 130/c.

Step 407

This step is seen in FIG. 4b. A PDU session is established and anchored in UPF/c 105/c. The session is between the UE 101 and the UPF/c 105/c.

Step 408

This step is seen in FIG. 4b. This corresponds to step 303 and step 304 in FIG. 3a. A data packet is sent from the UE 10 to anycast address #1, among the applicable at the UPF/c 105/c.

Step 409

This step is seen in FIG. 4b. This corresponds to step 305 in FIG. 3a. The UPF/c 105/c triggers the SMF 110 that anycast address #1 is detected.

Step 410

This step is seen in FIG. 4b. The UPF/c 105/c treats a data packet to anycast addr #1 according to policy. The normal policy may be e.g. to forward the packet to the DN/c 130/c.

Step 411

This step is seen in FIG. 4b. This corresponds to step 306 in FIG. 3a. The SMF 110 may insert the UPF/l 105/l in the data path, including the activation of the access at the applicable DNAI. The insertion of the UPF/l 105/l may be prepared in step 405. The UPF/l 105/l modifies its routing table to route the supported anycast addresses to the DN/l 130/l. The (R)AN 103 routes the uplink UE traffic to the UPF/l 110 as the anchor point.

Step 412

This step is seen in FIG. 4b. This corresponds to step 307 in FIG. 3a. An application comprised in the UE 101 retries the anycast address #1. It is a retry of the packet sending form step 408. Since the UPF/l 105/l has been inserted in the data path in step 411, the anycast address #1 will go to the UPF/l 105/l. For step 412 to occur, the application may need specific response to the UE 101 to trigger that.

Step 413

This step is seen in FIG. 4b. This corresponds to step 308 in FIG. 3a. The UPF/l 105/l routes the anycast address #1 to the DN/l 130/l.

FIG. 5a, FIG. 5b and FIG. 5c are signalling diagrams illustrating an example of an automated access to a DN/l 130/l with forward to a DN/c 130/c with IPv6MH breakout, i.e. alternative 2.1 in the list above. FIG. 5a illustrates steps 501-506, FIG. 5b illustrates steps 507-513 and FIG. 5c illustrates steps 514-518. FIG. 5c is a continuation of FIG. 5b, and FIG. 5b is a continuation of FIG. 5a such that steps 514-518 are performed after step 507-513, and steps 507-513 are performed after steps 501-506. The dotted arrows in FIGS. 5a, 5b and 5c represent control plane traffic and the solid arrows represent user plane traffic. The method illustrates in FIGS. 5a. 5b and 5c comprises at least one of the following steps, which steps may be performed in any suitable order than described below:

Step 501

This step is seen in FIG. 5a. This step corresponds to step 401 in FIG. 4a. The UE 101 sends a request for PDU session establishment to DNN #1. The request is sent to the SMF 110. DNN #1 is an example of a DNN to which the UE 101 requests session establishment, and any other DNN is equally applicable. The DNN #1 may also be referred to as a first DNN, DNN, short for Data Network Name is a name used to gain access to a DN 130. The UE 101 is at a location when sending the request, and this location may be referred to as TA #1 or a first TA.

Step 502

This step is seen in FIG. 5a. This step corresponds to step 402 in FIG. 4a. The SMF 110 receives the request from the UE 101. With the request, the SMF 110 receives DNN #1 and the UE location. The UE location may be for example TA #1.

Step 503

This step is seen in FIG. 5a. This step corresponds to step 301 in FIG. 3a and step 403 in FIG. 4a. This is an optional step. The SMF 110 may query the DB 135 to find if there are any anycast addresses supported at the DNAIs accessible from the UE's location. Together with the query, the SMF 110 sends the DNN #1 and TA #1 from step 402 to the DB 135. The DB 135 receives the query and may return at least one anycast address. The DB 135 returns at least one anycast address if there are any applications distributed to the DN/l 130/l. Thus, there may be one, two or more anycast addresses that are returned to the SMF 110. If there are two or more anycast addresses, then they may be organized in the form of a list of anycast addresses.

The SMF query may be omitted if the SMF 110 already has sufficiently recent information regarding the anycast addresses.

Step 504

This step is seen in FIG. 5a. This step corresponds to step 404 in FIG. 4a. This is an optional step. The SMF 110 may restrict the list of anycast addresses to those applicable for the subscription and service definitions.

Step 505

This step is seen in FIG. 5a. This step corresponds to step 405 in FIG. 4a. This is an optional step. The SMF 110 may prepare the inclusion of the UPF/l 105/l into the data path. With step 505, step 513 may be performed faster.

Step 506

This step is seen in FIG. 5a. This step corresponds to step 303 in FIG. 3a and step 406 in FIG. 4a. The SMF 110 instructs the UPF/c 105/c to report the usage of any of the applicable anycast addresses to the SMF 110.

User plane treatment is performed according to normal policy, usually to forward the packet to the DN/c 130/c.

Step 507

This step is seen in FIG. 5b. This step corresponds to step 407 in FIG. 4b. A PDU session is established and anchored in UPF/c 105/c. The session is between the UE 101 and the UPF/c 105/c.

Step 508

This step is seen in FIG. 5b. This step corresponds to step 303 and step 304 in FIG. 3a, and step 408 and 410 in FIG. 4b. A data packet is sent to anycast address #1 among the applicable at the UPF/c 105/c. The UPF/c 105/c treats a data packet to anycast addr #1 according to policy. The normal policy may be e.g. to forward the packet to the DN/c 130/c.

Step 509

This step is seen in FIG. 5b. This step corresponds to step 305 in FIG. 3a and step 409 in FIG. 4b. The UPF/c 105/c triggers the SMF 110 that anycast address #1 is detected.

Step 510

This step is seen in FIG. 5b. The SMF 110 sends a Router Advertisement (RA) to the UE 101. The RA indicates that the UE 101 should obtain a second routing indicator, e.g. a second IPv6 prefix or a second submask. In other words, the SMF 110 sends instructions to the UE 101 to obtain the second routing indcator.

Step 511

This step is seen in FIG. 5b. The UE 101 obtains and adds the second routing indcator and announced routes to its routing table.

Step 512

This step is seen in FIG. 5b. The application in the UE 101 opens a new Transmission Control Protocol (TCP) socket and matches a remote address towards the route with the Internet Protocol (IP) address, i.e. the anycast address. Since the UE 101 has got a new routing indcator (i.e. new IP address) and the route to the destination was less costly it wants to use the new address. To use the new address it has to open a new TCP socket to communicate over TCP. The new routing indicator is also referred to as a second routing indicator.

Step 513

This step is seen in FIG. 5b. This step corresponds to step 306 in FIG. 3a and step 411 in FIG. 4b. The SMF 110 may insert the UPF/l 105/l in the data path, including the activation of the access at the applicable DNAI. The insertion of the UPF/l 105/l may be prepared in step 505. The UPF/l 105/l modifies its routing table to route the supported anycast addresses to the DN/l 130/l. The (R)AN 103 routes the uplink UE traffic to the UPF/l 110 as the anchor point.

Step 514

This step is seen in FIG. 5c. This step corresponds to step 307 in FIG. 3a. The application comprised in the UE 101 retries the anycast address #1 using the initial UE address towards the UPF/l 105/l. This step is seen in FIG. 4b. Since the UPF/l 105/l has been inserted in the data path in step 513, the anycast address #1 will go to the UPF/l 105/l. For step 514 to occur, the application may need a specific response, e.g. a TCP Finish (FIN), to the UE 101 to trigger a new TCP connection. The initial UE address is the UE's address it had (and still has) before it received the new/second IPv6 prefix.

There need to be way for the application in the UE 101 doing the communication to understand that it shall switch to the new TCP socket for communication. For that reason the application in the UE 101 will try using the old TCP socket once more but when the traffic is broken out to the AS/l 133/l (at the UPF/l 105/l) it will not understand this TCP session and reply with a reset. Then the application in the UE 101 establishes a new TCP connection over the new TCP socket.

Step 515

This step is seen in FIG. 5c. This step corresponds to step 308 in FIG. 3a and step 412 in FIG. 4b. The UPF/l 105/l routes the anycast address #1 to the AS/l 133/l connected to the DN/l 130/l, i.e. to the DN/l 130/l.

Step 516

This step is seen in FIG. 5c. The AS/l 133/l sends instructions to the UE 101 to reset the current TCP connection if TCP is used as transport layer. The UE 101 resets the current TCP connection when receiving the instructions. The terms TCP connection and TCP session may be used interchangeably herein.

Step 517

This step is seen in FIG. 5c. The UE 101 re-tries the TCP session with the new routing indicator if TCP is used as transport layer. The retried TCP session is the reset TCP session. The new routing indicator is the one from step 511 in FIG. 5b. The new routing indicator is new compared to the old routing indicator used in step 508. The old routing indicator may be referred to as a first routing indicator and the new routing indicator may be referred to as a second routing indicator.

FIG. 6a and FIG. 6b are signalling diagrams illustrating an example of an automated access to a DN/l 130/l where packets to the DN/c 130/c is dropped and with ULCL breakout, i.e. alternative 1.2 above. FIG. 6a illustrates steps 601-606 and FIG. 6b illustrates steps 607-614. FIG. 6b is a continuation of step 6a such that steps 607-614 are performed after steps 601-606. The dotted arrows in FIGS. 6a and 6b represent control plane traffic and the solid arrows represent user plane traffic. Before the method steps take place, the UPF/c 105/c is installed and configured with a filter for application anycast address #1. The method illustrates in FIGS. 6a and 6b comprises at least one of the following steps, which steps may be performed in any suitable order than described below:

Step 601

This step is seen in FIG. 6a. This step corresponds to step 401 in FIG. 4a and step 501 in FIG. 5a. The UE 101 sends a request for PDU session establishment to DNN #1. The request is sent to the SMF 110. DNN #1 is an example of a DNN to which the UE 101 requests session establishment, and any other DNN is equally applicable. The DNN #1 may also be referred to as a first DNN. DNN is a name used to gain access to a DN 130. The UE 101 is at a location when sending the request, and this location may be referred to as TA #1 or a first TA.

Step 602

This step is seen in FIG. 6a. This step corresponds to step 402 in FIG. 4a and step 502 in FIG. 5a. The SMF 110 receives the request from the UE 101. With the request, the SMF 110 receives DNN #1 and the UE location. The UE location may be for example TA #1.

Step 603

This step is seen in FIG. 6a. This step corresponds to step 301 in FIG. 3a and step 403 in FIG. 4a and step 503 in FIG. 5a. This is an optional step. The SMF 110 may query the DB 135 to find if there are any anycast addresses supported at the DNAIs accessible from the UE's location. Together with the query, the SMF 110 sends the DNN #1 and TA #1 from step 402 to the DB 135. The DB 135 receives the query and may return at least one anycast address. The DB 135 returns at least one anycast address if there are any applications distributed to the DN/l 130/l. Thus, there may be one, two or more anycast addresses that are returned to the SMF 110. If there are two or more anycast addresses, then they may be organized in the form of a list of anycast addresses.

The SMF query may be omitted if the SMF 110 already has sufficiently recent information regarding the anycast addresses.

Step 604

This step is seen in FIG. 6a. This step corresponds to step 404 in FIG. 4a and step 504 in FIG. 5a. This is an optional step. The SMF 110 may restrict the list of anycast addresses to those applicable for the subscription and service definitions. The reason for doing the restriction is described earlier.

Step 605

This step is seen in FIG. 6a. This step corresponds to step 405 in FIG. 4a and step 505 in FIG. 5a. This is an optional step. The SMF 110 may prepare the inclusion of the UPF/l 105/l into the data path. With step 605, step 611 may be performed faster.

Step 606

This step is seen in FIG. 6a. This step corresponds to step 302 in FIG. 3a. The SMF 110 instructs the UPF/c 105/c to report the usage of any of the applicable anycast addresses to the SMF 110. The UPF/c 105/c is also instructed by the SMF 110 to drop packets to the applicable anycast addresses and optionally generate and send an error message towards the UE 101. The error is that a packet has been dropped to a certain anycast address.

Step 607

This step is seen in FIG. 6b. This step corresponds to step 407 in FIG. 4b and step 507 in FIG. 5b. A PDU session is established and anchored in UPF/c 105/c. The session is between the UE 101 and the UPF/c 105/c.

Step 608

This step is seen in FIG. 6b. This step corresponds to step 303 and step 304 in FIG. 3a and step 408 in FIG. 4b. A data packet is sent from the UE 101 to anycast address #1 among the applicable at the UPF/c 105/c.

Step 609

This step is seen in FIG. 6b. This step corresponds to step 305 in FIG. 3a and step 409 in FIG. 4b and step 509 in FIG. 5b. The UPF/c 105/c triggers the SMF 110 that anycast address #1 is detected.

Step 610

This step is seen in FIG. 6b. The UPF/c 105/c drops packets to anycast address #1.

Step 611

This step is seen in FIG. 6b. This step corresponds to step 306 in FIG. 3a and step 411 in FIG. 4a and step 513 in FIG. 5b. The SMF 110 may insert the UPF/l 105/l in the data path, including the activation of the access at the applicable DNAI. The insertion of the UPF/l 105/l may be prepared in step 605. The UPF/l 105/l modifies its routing table to route the supported anycast addresses to the DN/l 130/l. The (R)AN 103 routes the uplink UE traffic to the UPF/l 110 as the anchor point.

Step 612

This step is seen in FIG. 6b. This is an optional step. The UPF/c 105/c sends a message to the UE 101, via the UPF/l 105/l, to trigger UE 101 to retry the anycast address #1.

Step 613

This step is seen in FIG. 6b. This step corresponds to step 307 in FIG. 3a. The application comprised in the UE 101 retries the anycast address #1. This step 613 may be in response to step 612 or at a timeout at the UE 101. Since the UPF/l 105/l has been inserted in the data path in step 611, the anycast address #1 will go to the UPF/l 105/l. For step 613 to occur, the UE 101 has to apply a retry scheme when no response is received.

Step 614

This step is seen in FIG. 6b. This step corresponds to step 308 in FIG. 3a and step 413 in FIG. 4b. The UPF/l routes the anycast address #1 to the DN/l 130/l.

FIG. 7a, FIG. 7b and FIG. 7c are signalling diagrams illustrating an example of an automated access to a DN/l 130/l with dropping packets to the DN/c 130/c with IPv6MH breakout, i.e. alternative 2.2 in the list above. FIG. 7a illustrates steps 701-706, FIG. 7b illustrates steps 707-714 and FIG. 7c illustrates steps 715-717. FIG. 7c is a continuation of FIG. 7b, and FIG. 7b is a continuation of FIG. 7a such that steps 715-717 are performed after step 707-714, and steps 707-714 are performed after steps 701-706. The dotted arrows in FIGS. 7a, 7b and 7c represent control plane traffic and the solid arrows represent user plane traffic. Before the method steps take place, the UPF/c 105/c is installed and configured with a filter for app anycast address #1 The method illustrates in FIGS. 7a, 7b and 7c comprises at least one of the following steps, which steps may be performed in any suitable order than described below:

Step 701

This step is seen in FIG. 7a. This step corresponds to step 401 in FIG. 4a, step 501 in FIG. 5a and step 601 in FIG. 6a. The UE 101 sends a request for PDU session establishment to DNN #1. The request is sent to the SMF 110. DNN #1 is an example of a DNN to which the UE 101 requests session establishment, and any other DNN is equally applicable. The DNN #1 may also be referred to as a first DNN, DNN, short for Data Network Name is a name used to gain access to a DN 130. The UE 101 is at a location when sending the request, and this location may be referred to as TA #1 or a first TA.

Step 702

This step is seen in FIG. 7a. This step corresponds to step 402 in FIG. 4a, step 502 in FIGS. 5a and step 602 in FIG. 6a. The SMF 110 receives the request from the UE 101. With the request, the SMF 110 receives DNN #1 and the UE location. The UE location may be for example TA #1.

Step 703

This step is seen in FIG. 7a. This step corresponds to step 301 in FIG. 3a and step 403 in FIG. 4a, step 503 in FIG. 5a and step 603 in FIG. 6a. This is an optional step. The SMF 110 may query the DB 135 to find if there are any anycast addresses supported at the DNAIs accessible from the UE's location. Together with the query, the SMF 110 sends the DNN #1 and TA #1 from step 402 to the DB 135. The DB 135 receives the query and may return at least one anycast address. The DB 135 returns at least one anycast address if there are any applications distributed to the DN/l 130/l. Thus, there may be one, two or more anycast addresses that are returned to the SMF 110. If there are two or more anycast addresses, then they may be organized in the form of a list of anycast addresses.

The SMF query may be omitted if the SMF 110 already has sufficiently recent information regarding the anycast addresses.

Step 704

This step is seen in FIG. 7a. This step corresponds to step 404 in FIG. 4a, step 504 in FIG. 5a and step 604 in FIG. 6a. This is an optional step. The SMF 110 may restrict the list of anycast addresses to those applicable for the subscription and service definitions. The reason for the restriction is described earlier.

Step 705

This step is seen in FIG. 7a. This step corresponds to step 405 in FIG. 4a, step 505 in FIGS. 5a and step 605 in FIG. 6a. This is an optional step. The SMF 110 may prepare the inclusion of the UPF/l 105/l into the data path. With step 705, step 714 may be performed faster.

Step 706

This step is seen in FIG. 7a. This step corresponds to step 302 in FIG. 3a and step 406 in FIG. 4a. The SMF 110 instructs the UPF/c 105/c to report the usage of any of the applicable anycast addresses to the SMF 110. The UPF/c 105/c is also instructed by the SMF 110 to drop packets to the applicable anycast addresses and optionally generate and send an error message towards the UE 101. The error is that a packet has been dropped.

Step 707

This step is seen in FIG. 7b. This step corresponds to step 407 in FIG. 4b, step 507 in FIG. 5b and step 607 in FIG. 6b. A PDU session is established and anchored in UPF/c 105/c. The session is between the UE 101 and the UPF/c 105/c.

Step 708

This step is seen in FIG. 7b. This step corresponds to step 303 and step 304 in FIG. 3a and step 508 in FIG. 5b. A data packet is sent to anycast address #1 among the applicable at the UPF/c 105/c. The UPF/c 105/c forwards the data packet to the AS/c 133/c.

Step 709

This step is seen in FIG. 7b. This step corresponds to step 305 in FIG. 3a and step 409 in FIG. 4b, step 509 in FIG. 5b and step 609 in FIG. 6b. The UPF/c 105/c triggers the SMF 110 that anycast address #1 is detected.

Step 710

This step is seen in FIG. 7b. This step corresponds to step 410 in FIG. 4b. The UPF/c 105/c drops packets to anycast address #1.

Step 711

This step is seen in FIG. 7b. This step corresponds to step 510 in FIG. 5b. The SMF 110 sends a RA to the UE 101. The RA indicates that the UE 101 should obtain a second routing indicator. The second routing indicator may be a second IPv6 prefix or a second subnet mask.

Step 712

This step is seen in FIG. 7b. This step corresponds to step 511 in FIG. 5b. The UE 101 obtains and adds the second routing indicator and announced routes to its routing table.

Step 713

This step is seen in FIG. 7b. This step corresponds to step 512 in FIG. 5b. The application in the UE 101 opens a new TCP socket and matches the anycast address towards the route with the IP address, i.e. the anycast address. The reason or opening a new TCP socket is that it received a new routing indicator and wants to use that.

Step 714

This step is seen in FIG. 7b. This step corresponds to step 306 in FIG. 3a and step 411 in FIG. 4b, step 513 in FIG. 5b and step 611 in FIG. 6b. The SMF 110 may insert the UPF/l 105/l in the data path, including the activation of the access at the applicable DNAI. The insertion of the UPF/l 105/l may be prepared in step 705. The UPF/l 105/l modifies its routing table to route the supported anycast addresses to the DN/l 130/l. The (R)AN 103 routes the uplink UE traffic to the UPF/l 110 as the anchor point.

Step 715

This step is seen in FIG. 7c. The AS/c 133/c sends a message to the UE 101, via the UPF/c 105/c, to trigger UE 101 to retry the anycast address #1. For step 715 to occur, the application need specific response, e.g. a TCP FIN, to the UE 101 to trigger a new TCP connection.

Step 716

This step is seen in FIG. 7c. This step corresponds to step 307 in FIG. 3a and step 514 in FIG. 5b. The application comprised in the UE 101 retries the anycast address #1 using new routing indicator if TCP is used as transport layer.

Step 717

This step is seen in FIG. 7c. This step corresponds to step 308 in FIG. 3a and step 515 in FIG. 5c. The UPF/l 105/l routes the anycast address #1 to the DN/l 130/l.

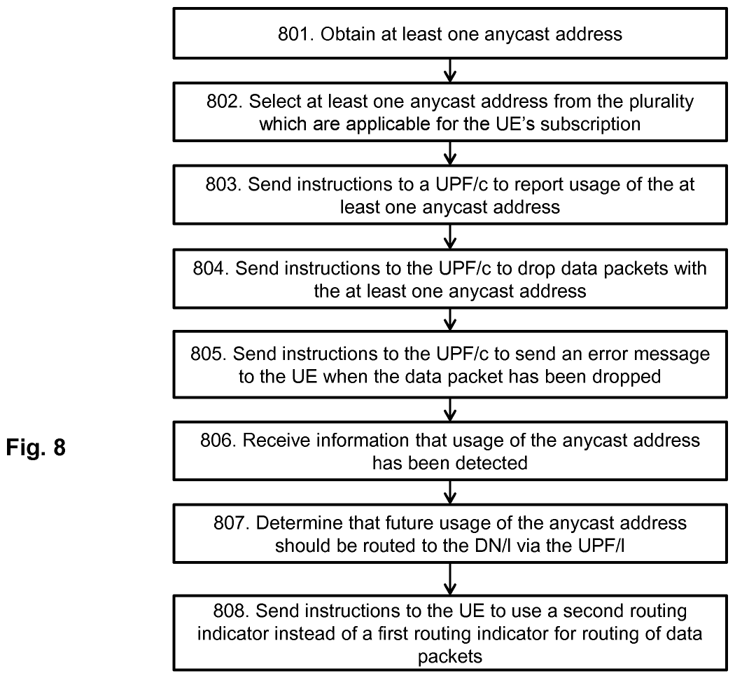

The method described above will now be described seen from the perspective of the SMF 110. FIG. 8 is a flowchart describing the present method in the SMF 110, for handling a UE 101 access to a DN 130 in a 5G communications system. The method comprises at least one of the following steps to be performed by the SMF 110:

Step 801

This step corresponds to step 301 in step 3a, step 403 in FIG. 4a, step 503 in FIG. 5a, step 603 in FIG. 6a and step 703 in FIG. 7a. The SMF 110 obtains at least one anycast address supported at a DN/l 130/l which is accessible by the UE 101 from its location. The location may be referred to as a UE location or UE position.

The at least one anycast address may be obtained by sending a request for the anycast address to a DB 135 and receiving a response with the requested at least one anycast address from the DB 135.

The anycast address may be obtained internally in the SMF 110. The SMF 110 may either keep an internal DB comprising the anycast address or it may have recently already made a request to the DB 135, which makes it unnecessary to ask again. This keeps the amount of signalling down.

The SMF 110 may have obtained the UE location and the DN/l 130/l prior to step 801.

Step 802

This step corresponds to step 404 in FIG. 4a, step 504 in FIG. 5a, step 604 in FIGS. 6a and step 704 in FIG. 7a. When there is a plurality of obtained anycast addresses, the SMF 110 may select at least one anycast address from the plurality which is applicable for the UE's 101 subscription.

Step 803

This step corresponds to step 302 in FIG. 3a, step 406 in FIG. 4a, step 506 in FIG. 5a, step 606 in FIG. 6a and step 706 in FIG. 7a. The SMF 110 sends instructions to a UPF/c 105/c to report usage of the at least one anycast address.

Step 804

This step corresponds to step 606 in FIG. 6a and step 706 in FIG. 7a. The SMF 110 may send instructions to the UPF/c 105/c to drop data packets with the at least one anycast address. The data packets that may be dropped may be future data packets. It may be only the packets received at the DN/c 130/c that should be dropped since it is desired that the packets end up in the DN/l 130/l instead.

Step 805

This step corresponds to step 606 in FIG. 6a and step 706 in FIG. 7a. The SMF 110 may send instructions to the UPF/c 130/c to send an error message to the UE 101 when the data packet has been dropped.

Step 806

This step corresponds to step 305 in FIG. 3a, step 409 in FIG. 4b, step 509 in FIG. 5b, step 609 in FIG. 6b and step 709 in FIG. 7b. The SMF 110 receives, from the UPF/c 105/c, information that usage of the anycast address has been detected.

Step 807

This step corresponds to step 306 in FIG. 3a, step 411 in FIG. 4b, step 513 in FIG. 5b, step 611 in FIG. 6b and step 714 in FIG. 7b. When usage of the anycast address has been detected, the SMF 110 determines that future usage of the anycast address should be routed to the DN/l 130/l via the UPF/l 105/l.

The DN/c 130/c and the DN/l 130/l may both provide the same service requested by the UE 101.

The anycast address may have been used by an application comprised in the UE 101 for accessing the DN/c 130/c.

Step 808

This step corresponds to step 307 in FIG. 7a, step 510 in FIG. 5b and step 711 in FIG. 7b. When the anycast address usage has been detected, the SMF 110 may send instructions to the UE 101 to use a second routing indicator instead of a first routing indicator for routing of data packets. The second routing indicator may be a second IPv6 prefix or a second subnet mask. The first routing indicator may be a first IPv6 prefix or a first subnet mask.

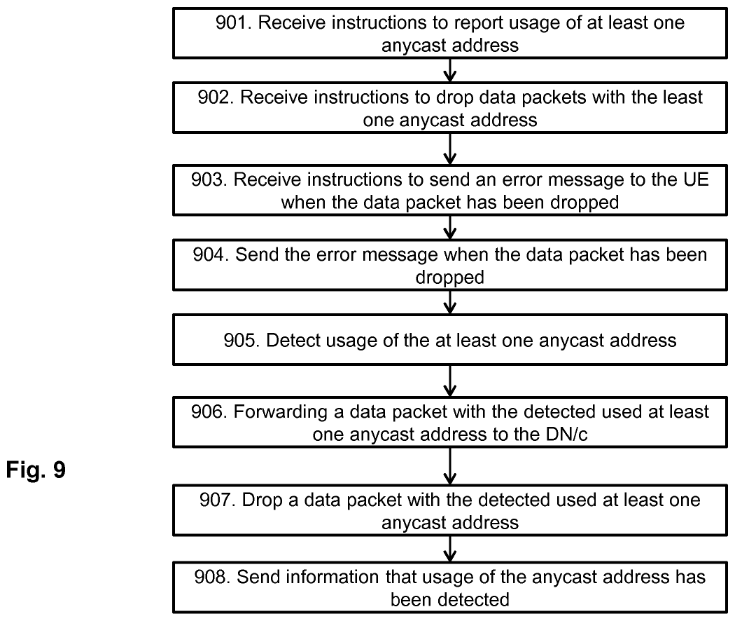

The method described above will now be described seen from the perspective of the UPF/c 105/c. FIG. 9 is a flowchart describing the present method in the UPF/c 105/c, for handling a UE 101 access to a DN 130 in a 5G communications system. The method comprises at least one of the following steps to be performed by the UPF/c 105/c:

Step 901

This step corresponds to step 302 in FIG. 3a, step 406 in FIG. 4a, step 506 in FIG. 5a, step 606 in FIG. 6a and step 706 in FIG. 7a. The UPF/c 105/c receives instructions from a SMF 110 to report usage of at least one anycast address. The at least one anycast address is supported at a DN/l 130/l which is accessible by the UE 101 from its location.

Step 902

This step corresponds to step 606 in FIG. 6a and step 706 in FIG. 7a. The UPF/c 105/c may receive instructions from the SMF 110 to drop data packets with the least one anycast address. The data packets to be dropped have the anycast address as destination address.

Step 903

This step corresponds to step 606 in FIG. 6a and step 706 in FIG. 7a. The UPF/c 105/c may receive instructions from the SMF 110 to send an error message to the UE 101 when the data packet has been dropped.

Step 904

The UPF/c 105/c may send the error message to the UE 101 when the data packet has been dropped.

Step 905

This step corresponds to step 304 in FIG. 3a, step 408 in FIG. 4b, step 508 in FIG. 5b, step 608 in FIG. 6b and step 708 in FIG. 7b. The UPF/c 105/c detects usage of the at least one anycast address. The anycast address has been used to access a DN/c 130/c via the UPF/c 105/c. Using other words, the UPF/c 105/c detects a data packet having an anycast destination which the UPF/c 105/c is instructed to detect.

Step 906

This step corresponds to step 410 in FIG. 4b and step 508 in FIG. 5b. When the usage has been detected, the UPF/c 105/c may forward a data packet with the detected used at least one anycast address to the DN/c 130/c. The data packet is the one with the anycast address as destination address to the DN/c 130/c.

Step 907

This step corresponds to step 610 in FIG. 6b and step 710 in FIG. 7b. The UPF/c 105/c may drop a data packet with the detected used at least one anycast address. The data packet to be dropped has the anycast address as destination address to the DN/c 130/c.

Step 908

This step corresponds to step 305 in FIG. 3a, step 409 in FIG. 4b, step 509 in FIG. 5b, step 609 in FIG. 6b and step 709 in FIG. 7b. The UPF/c 105/c sends to the SMF 110, information that usage of the anycast address has been detected.

In step 905, the UPF/c 105/c detects that an application in the UE 101 has tried to access the AS 133 somewhere. The first hit will be in the DN/c 130/c, and when the UPF/l 105/l is inserted in the path, the next hit will be in the DN/l 130/l.

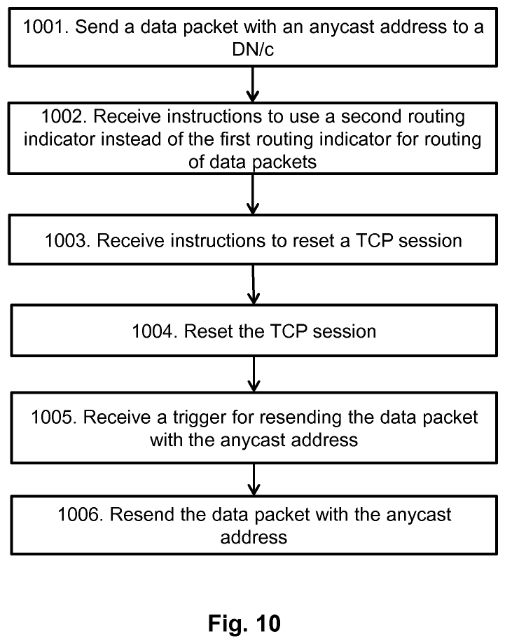

The method described above will now be described seen from the perspective of the UE 101. FIG. 10 is a flowchart describing the present method in the UE 101, for handling a UE 101 access to a DN 130 in a 5G communications system. The method comprises at least one of the following steps to be performed by the UE 101:

Step 1001

This step corresponds to step 303 in FIG. 3a. The UE 101 sends a data packet with an anycast address to a DN/c 130/c. The data packet has an anycast address as destination address.

The data packet may be further sent with a first IPv6 prefix.

Step 1002

This step corresponds to step 510 in FIG. 5b and step 711 in FIG. 7b. The UE 101 may receive instructions from a SMF 110 to use a second routing indicator instead of the first routing indicator for routing of data packets. The second routing indicator may be a second IPv6 prefix or a second subnet mask. The first routing indicator may be a first IPv6 prefix or a first subnet mask.

Step 1003

This step corresponds to step 516 in FIG. 5c. If TCP is used as transport layer for sending the data packet, the UE 101 may receive instructions to reset a TCP session from the DN/l 130/l.

Step 1004

This step corresponds to step 516 in FIG. 5c. The UE 101 may reset the TCP session.

Step 1005

This step corresponds to step 612 in FIG. 6b and step 715 in FIG. 7c. The UE 101 may receive, from either a UPF/c 105/c or a UPF/l 105/l, a trigger for resending the data packet with the anycast address.

Step 1006

This step corresponds to step 307 in FIG. 3a. The UE 101 resends the data packet with the anycast address.

The data packet may be resent with the second routing indicator. The data packet may be resent on the reset TPC session.

The resending of the anycast address may be done with the second routing indicator when TCP is used as transport layer for sending the data packet with the first routing indicator.

The data packet may be resent when a timer for receiving a response for sending the data packet has expired.

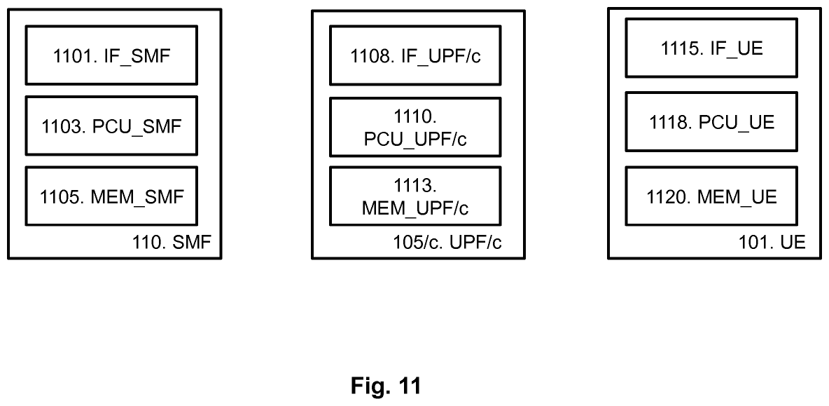

In FIG. 11, there is shown a SMF 110 comprising a processor PCU_SMF 1101, an interface IF_SMF 1103 and a memory, MEM_SMF 1105, in which memory instructions are stored for carrying out the method steps explained above. The SMF 110 communicates via the interface IF_SMF 1103. The IF_SMF 1103 comprises both an external interface, communicating with a transmitter and receiver, and internal interfaces (not shown).

The SMF 110 is operative to, e.g. by means of the PCU_AMF 1101, obtain at least one anycast address supported at a DN/l 130/l which is accessible by a UE 101 from its location. The at least one anycast address may be obtained by sending a request for the anycast address to a DB 135 and receiving a response with the requested at least one anycast address from the DB 135. The anycast address may be obtained internally in the SMF 110.

The SMF 110 is further operative to, e.g. by means of the PCU_SMF 1101, send instructions to a UPF/c 105/c to report usage of the at least one anycast address. The SMF 110 is operative to, e.g. by means of the PCU_AMF 1101, receive, from the UPF/c 105/c, information that usage of the anycast address has been detected. The SMF 110 is operative to, e.g. by means of the PCU_AMF 1101, when usage of the anycast address has been detected, determine that future usage of the anycast address should be routed to the DN/l 130/l via a UPF/l 105/l.

The SMF 110 may be further operative to, e.g. by means of the PCU_SMF 1101, when there is a plurality of obtained anycast addresses, select at least one anycast address from the plurality which are applicable for the UE's 101 subscription.

The SMF 110 may be further operative to, e.g. by means of the PCU_SMF 1101, when the anycast address usage has been detected, send instructions to the UE 101 to use a second routing indicator instead of a first routing indicator for routing of data packets. The second routing indicator may be a second IPv6 prefix or a second subnet mask. The first routing indicator may be a first IPv6 prefix or a first subnet mask.

The SMF 110 may be further operative to, e.g. by means of the PCU_SMF 1101, send instructions to the UPF/c 105/c to drop data packets with the at least one anycast address.

The SMF 110 may be further operative to, e.g. by means of the PCU_SMF 1101, send instructions to the UPF/c 130/c to send an error message to the UE 101 when the data packet has been dropped.

FIG. 11 also shows a UPF/c 105/c comprising a processor PCU_UPF/c 1108, an interface IF_UPF/c 1110, and a memory, MEM_UPF/c 1113, in which memory instructions are stored for carrying out the method steps explained above. The UPF/c 105/c communicates via the interface IF_UPF/c 1110. The IF_UPF/c 1110 comprises both an external interface, communicating with a transmitter and receiver, and internal interfaces (not shown).

The UPF/c 105/c is operative to, e.g. by means of the PCU_UPF/c 1108, receive instructions from a SMF 110 to report usage of at least one anycast address. The at least one anycast address is supported at a DN/l 130/l which is accessible by a UE 101 from its location.

The UPF/C 105/c is operative to, e.g. by means of the PCU_UPF/c 1108, detect usage of the at least one anycast address. The anycast address has been used to access a DN/c 130/c via the UPF/c 105/c.

The UPF/C 105/c is operative to, e.g. by means of the PCU_UPF/c 1108, send, to the SMF 110, information that usage of the anycast address has been detected.

The UPF/c 105/c may be further operative to, e.g. by means of the PCU_UPF/c 1108, when the usage has been detected, forward a data packet with the detected used at least one anycast address to the DN/c 130/c.

The UPF/c 105/c may be further operative to, e.g. by means of the PCU_UPF/c 1108, drop a data packet with the detected used at least one anycast address.

The UPF/c 105/c may be further operative to, e.g. by means of the PCU_UPF/c 1108, receive instructions from the SMF 110 to drop data packets with the least one anycast address.

The UPF/c 105/c may be further operative to, e.g. by means of the PCU_UPF/c 1108, receive instructions from the SMF 110 to send an error message to the UE 101 when the data packet has been dropped, and to send the error message to the UE 101 when the data packet has been dropped.

Further, FIG. 11 shows a UE 101 comprising a processor PCU_UE 1115, an interface IF_UE 1118, and a memory, MEM_UE 1120, in which memory instructions are stored for carrying out the method steps explained above. The UE 101 communicates via the interface IF_UE 1118. The IF_UE 1118 comprises both an external interface, communicating with a transmitter and receiver, and internal interfaces (not shown).

The UE 101 is operative to, e.g. by means of the PCU_UE 1115, send a data packet with an anycast address to a DN/c 130/c, and to resend the data packet with the anycast address.

The data packet may be further sent with a first routing indicator.

The UE 101 may be further operative to, e.g. by means of the PCU_UE 1115, receive instructions from a SMF 110 to use a second routing indicator instead of the first routing indicator for routing of data packets, The data packet may be resent with the second routing indicator. The second routing indicator may be a second IPv6 prefix or a second subnet mask. The first routing indicator may be a first IPv6 prefix or a first subnet mask.

The UE 101 may be further operative to, e.g. by means of the PCU_UE 1115, if TCP, is used as transport layer for sending the data packet, receive instructions to reset a TCP session from a DN/l 130/l; and to reset the TCP session. The data packet may be resent on the reset TPC session.

The UE 101 may be further operative to, e.g. by means of the PCU_UE 1115, resend of the anycast address is done with the second routing indicator when TCP is used as transport layer for sending the data packet with the first routing indicator.

The UE 101 may be further operative to, e.g. by means of the PCU_UE 1115, receive, from either a UPF/c 105/c or a UPF/l 105/l, a trigger for resending the data packet with the anycast address.

The data packet may be resent when a timer for receiving a response for sending the data packet has expired.

The entities in FIG. 11 are adapted to communicate over known external telecom interfaces or via application programming interfaces (API), as appropriate.

It is noted that the features of the methods described above and in the following, may be implemented in software and carried out on a data processing device or other processing means caused by the execution of program code means such as computer-executable instructions. Here and in the following, the term processing means comprises any circuit and/or device suitably adapted to perform the above functions. In particular, the above term comprises general- or special-purpose programmable microprocessors, Digital Signal Processors (DSP), Application Specific Integrated Circuits (ASIC), Programmable Logic Arrays (PLA), Field Programmable Gate Arrays (FPGA), special purpose electronic circuits, etc., or a combination thereof. For example, the program code means may be loaded in a memory, such as a RAM (Random Access Memory), from a storage medium, such as a read-only memory (ROM) or other non-volatile memory, such as flash memory, or from another device via a suitable data interface, the described features may be implemented by hardwired circuitry instead of software or in combination with software.

A computer program or computer program product is provided carrying out the method steps defined above. A carrier may comprise the computer program, and the carrier may be one of an electronic signal, optical signal, radio signal or computer readable storage medium.

Some embodiments described herein may be summarised in the following manner:

A prerequisite for the embodiments herein may be that services to be supported and made available both at a DN/c 130/c and a DN/l 130/l is reached by the UE 101 contacting an anycast address.

The UPF 105 that is configured to support access to a DN/l 130/l, serving a specific DNN, and has been assigned a DNAI for that purpose may also collect and record the available anycast addresses at the DN/l 130/l together with the DNAI in the same database as the SMF 110 uses or UPF/l lookup. E.g. for IPv6 collecting, the anycast addresses received with the RA from the DN 130.

The SMF 110 has access to the present network status by querying the DB 135 on a per need basis. The SMF 110 may subscribe to notifications from the DB 135 due to database updates as well as maintain a local cache of the present status, sharing the status among all PDU sessions where the UEs 101 are in an area of same support for local services. Such methods help limiting the query rate towards the DB 135. There may be a central DB 135 where the applicable anycast address(es) serving each service is recorded. From this DB 135, the SMF 110 may tailor the set of anycast addresses that might be served by a DN/l 130/l for each specific PDU session.

The SMF 110 may follow the UE mobility to the granularity required in relation to the subscription. This applies at connection set-up as well as at mobility.

The SMF 110 acquires at PDU session establishment information on the anycast addresses that can be served locally, building a candidate DNAI list, preferably with restriction to the anycast addresses that are applicable for the subscription.

The SMF 110 may share the information as to anycast addresses that can be served locally across PDU sessions to the same DNN for UEs 101 in the same location/area. The restriction to services applicable for the subscription may still need to be per PDU session.

The SMF 110 may be informed and may act on changes with respect to:
Available anycast addresses at each DNAI.
UE location changes that may require the set of anycast addresses to be monitored to change.
Modifications in the set of services/service configurations available.
Changes to the UE subscription, if the SMF 110 practices restriction to subscribed services.

The SMF 110 prepares the traffic inspection for the traffic that should be served by a DN/l 130/l, at the UPF/c 105/c. The traffic inspection is to detect UL traffic towards any of the anycast addresses that are relevant for the PDU session. Matching traffic, i.e. detected usage of the applicable anycast address, may be treated according to one of the following alternatives:
(a) Let the traffic pass, (FIG. 4a-4b) and let the session time out, the UE 101 re-sends the first message with the first (central) IPv6 prefix and it is offloaded at the UPF/l 105/l to the AS/l 133/l. The AS/l 133/l will not recognize the session so it will send a Reset back to the UE 101 and then the UE 101 will re-try with a new TCP session (if TCP is used) and a new IP address, the new/local routing indicator provided at the detection of the anycast address in the initial communication.
(b) Drop the traffic. FIG. 5a, 5b, 5c. The AS/c 133/c may return an error message to the UE 101, once the AS/c 133/c has been reached while there is a AS/l 133/l available at a DN/l 130/l closer to the UE location. In case of TCP as transport protocol, a TCP SYN may be sent from the AS/c 133/c to trigger a restart of a new TCP session/Socket. For UDP and QUIC this rely on application protocol level handling to reset the connection and start a new socket/new IP address.

The UPF/c reports to the SMF 110 in both cases a) and b) that traffic with the used anycast address has been detected.

The traffic inspection at the UPF/c 105/c may be organized per service, one case for the whole PDU session or according to any other suitable structure.

When the UPF/c 105/c detects traffic towards a monitored anycast address, the SMF 110 inserts a suitable UPF/l 105/l for example based on the information available in the network resource database, informing about possible DNAI(s) etc.

For the UPF action a) above, let the traffic pass/forward the data packet: The SMF 110 inserts the applicable UPF/l 105/l in the traffic path. The application in the UE 101 may be expected to handle the diversion of the service to the DN/l 130/l by forcing the UE 101 to re-try, starting over with the anycast address, e.g. by the central server not responding/indicating a temporary unavailability etc.

For the UPF action b) above, drop the traffic and send message to UE 101: The UE 101 may be expected to re-try its request with the second routing indicator at a time when the DN/l access has been established. The SMF 110 actions may be the same as for action a). This has the same effect as the AS/c 133/c not responding at all.

The embodiments herein are applicable both to legacy Physical Network Functions (PNF), i.e. integrated nodes, as well as to cloud deployments though Virtual Network Functions (VNFs).

The embodiments herein are not limited to the above described embodiments. Various alternatives, modifications and equivalents may be used. Therefore, the above embodiments should not be taken as limiting the scope of the embodiments, which is defined by the appended claims. A feature from one embodiment may be combined with one or more features of any other embodiment.

It should be emphasized that the term “comprises/comprising” when used in this specification is taken to specify the presence of stated features, integers, steps or components, but does not preclude the presence or addition of one or more other features, integers, steps, components or groups thereof. It should also be noted that the words “a” or “an” preceding an element do not exclude the presence of a plurality of such elements.

The term “configured to” used herein may also be referred to as “arranged to”, “adapted to”, “capable of” or “operative to”.

The term “at least one of A and B” should be understood to mean “only A, only B, or both A and B.”

It should also be emphasised that the steps of the methods defined in the appended claims may, without departing from the embodiments herein, be performed in another order than the order in which they appear in the claims.

1-36. (canceled)

37. A method, performed by a Session Management Function (SMF), for handling a User Equipment's (UE) access to a Data Network (DN) in a Fifth Generation (5G) communications system, the method comprising:
obtaining at least one anycast address supported at a local Data Network (DN/l) which is accessible by the UE from its location;
sending instructions to a central User Plane Function (UPF/c) to report usage of the at least one anycast address;
receiving, from the UPF/c, information that usage of the anycast address has been detected; and
determining, in response to usage of the anycast address being detected, that future usage of the anycast address should be routed to the DN/l via a local UPF (UPF/l).

38. The method of claim 37, where the at least one anycast address is obtained by sending a request for the anycast address to a database (DB), and receiving a response with the requested at least one anycast address from the DB.

39. The method of claim 37, wherein the anycast address is obtained internally in the SMF.

40. The method of claim 37, further comprising selecting, when there is a plurality of obtained anycast addresses, at least one anycast address from the plurality which are applicable for the UE's subscription.

41. The method of claim 37, further comprising sending, in response to usage of the anycast address being detected, instructions to the UE to use a second routing indicator instead of a first routing indicator for routing of data packets.

42. The method of claim 37, further comprising sending instructions to the UPF/c to drop data packets with the at least one anycast address.

43. The method of claim 42, further comprising sending instructions to the UPF/c to send an error message to the UE when the data packet has been dropped.

44. A method, performed by a central User Plane Function (UPF/c), for handling a User Equipment's (UE) access to a Data Network (DN) in a Fifth Generation (5G) communications system, the method comprising:
receiving instructions from a Session Management Function (SMF) to report usage of at least one anycast address, wherein the at least one anycast address is supported at a local Data Network (DN/l) which is accessible by the UE from its location;
detecting usage of the at least one anycast address, wherein the anycast address has been used to access a central Data Network (DN/c) via the UPF/c; and
sending, to the SMF, information that usage of the anycast address has been detected.

45. The method of claim 44, further comprising forwarding, in response to the usage of the at least one anycast address being detected, a data packet with the detected used at least one anycast address to the DN/c.

46. The method of claim 44, further comprising dropping a data packet with the detected used at least one anycast address.

47. The method of claim 46, further comprising receiving instructions from the SMF to drop data packets with the least one anycast address.

48. The method of claim 46, further comprising:
receiving instructions from the SMF to send an error message to the UE when the data packet has been dropped; and
sending the error message to the UE when the data packet has been dropped.

49. A Session Management Function (SMF) in a Fifth Generation (5G) communications system, the SMF comprising:
processing circuitry;
memory containing instructions executable by the processing circuitry whereby the SMF is operative to:
obtain at least one anycast address supported at a local Data Network (DN/l), which is accessible by a User Equipment (UE) from its location;
send instructions to a central User Plane Function (UPF/c) to report usage of the at least one anycast address;
receive, from the UPF/c, information that usage of the anycast address has been detected; and
determine, in response to usage of the anycast address being detected, that future usage of the anycast address should be routed to the DN/l via a local User Plane Function (UPF/l).

50. The SMF of claim 49, wherein the instructions are such that the SMF is operative to obtain the at least one anycast address by sending a request for the anycast address to a database (DB), and receiving a response with the requested at least one anycast address from the DB.

51. The SMF of claim 49, wherein the instructions are such that the SMF is operative to obtain the anycast address internally in the SMF.

52. A central User Plane Function (UPF/c) in a Fifth Generation (5G) communications system, the UPF/c comprising:
processing circuitry;
memory containing instructions executable by the processing circuitry whereby the UPF/c is operative to:
receive instructions from a Session Management Function (SMF) to report usage of at least one anycast address, wherein the at least one anycast address is supported at a local Data Network (DN/l) which is accessible by a User Equipment (UE) from its location;
detect usage of the at least one anycast address, wherein the anycast address has been used to access a central Data Network (DN/c) via the UPF/c; and
send, to the SMF, information that usage of the anycast address has been detected.

53. The UPF/c of claim 52, wherein the instructions are such that the UPF/c is operative to forward, when the usage of the anycast address has been detected, a data packet with the detected used at least one anycast address to the DN/c.

54. The UPF/c of claim 52, wherein the instructions are such that the UPF/c is operative to drop a data packet with the detected used at least one anycast address.

55. The UPF/c of claim 54, wherein the instructions are such that the UPF/c is operative to receive instructions from the SMF to drop data packets with the least one anycast address.

56. The UPF/c of claim 54, wherein the instructions are such that the UPF/c is operative to:
receive instructions from the SMF to send an error message to the UE when the data packet has been dropped; and
send the error message to the UE when the data packet has been dropped.
